(19) United States
(12) Patent Application Publication
(10) Pub. No.: US 2015/0087517 A1
(43) Pub. Date: Mar. 26, 2015

(54) MANUFACTURING OF SPECIFICALLY TARGETING MICROCAPSULES

(71) Applicant: AGROSAVFE N.V., Gent (BE)

(72) Inventors: Peter Verheesen, Gent (BE); Chris De Jonghe, Mortsel (BE)

(21) Appl. No.: 14/350,026

(22) PCT Filed: Oct. 8, 2012
(86) PCT No.: PCT/EP2012/069849

§ 371 Date: Apr. 4, 2014

(30) Foreign Application Priority Data
Oct. 6, 2011 (EP) 11184240.7

(51) Int. Cl. A01N 25/24; A01N 25/28; A01N 43/40; A01N 57/20; A01N 53/00

(52) U.S. Cl. CPC A01N 25/24; A01N 57/20; A01N 53/00; A01N 43/40; A01N 25/28
USPC 504/206; 514/521; 514/352; 424/491; 264/4.33

(57) ABSTRACT

The present disclosure relates to the manufacturing of specifically targeting microcapsules comprising agrochemicals. More specifically, the disclosure relates to specifically targeting microcapsules, to which targeting agents are covalently linked at a ratio from about 0.01 μg-to about 1 μg targeting agents per square centimeter of the surface of the microcapsule, such that the microcapsules are capable of binding the agrochemicals contained in the microcapsules to a surface, and to agrochemical compositions comprising such microcapsules.

### CROSS-REFERENCE TO RELATED APPLICATIONS

This application is a national phase entry under 35 U.S.C. §371 of International Patent Application PCT/EP2012/069849, filed Oct. 8, 2012, designating the United States of America and published in English as International Patent Publication WO2013/050594 A1 on Apr. 11, 2013, which claims the benefit under Article 8 of the Patent Cooperation Treaty to United Kingdom Application Serial No. 11184240.7, filed Oct. 6, 2011.

### TECHNICAL FIELD

The disclosure relates to the manufacturing of specifically targeting microcapsules comprising agrochemicals. More specifically, the disclosure relates to specifically targeting microcapsules, to which targeting agents are covalently linked at a ratio from about 0.01 μg to about 1 μg targeting agents per square centimeter of the surface of the microcapsule, such that the microcapsules are capable of binding the agrochemicals contained in the microcapsules to a surface, and to agrochemical compositions comprising such microcapsules.

### BACKGROUND

Agrochemicals are widely used in agriculture, amongst others to kill unwanted weeds, to control insects, fungi or other plant pests and diseases and/or to stimulate plant growth. However, when a composition comprising such agrochemicals is applied to a plant, only a small amount of the composition reaches the sites of action on the plant where a desired biological activity of the agrochemical can be usefully expressed. In order to solve the problem, the agrochemicals can be incorporated in or on a carrier that sticks to the plant and releases its content over a certain period of time. U.S. Pat. No. 6,180,141 describes composite gel microparticles that can be used to deliver plant-protection active principles. WO 2005102045 describes compositions comprising at least one phyto-active compound and an encapsulating adjuvant, wherein the adjuvant comprises a fungal cell or a fragment thereof. US20070280981 describes carrier granules, coated with a lipophilic tackifier on the surface, whereby the carrier granule adheres to the surface of plants, grasses and weeds.

Those microparticles, intended for the delivery of agrochemicals, are characterized by the fact that they stick to the plant by rather weak, a specific interactions, such as a lipophilic interaction. Although this may have advantages compared with the normal spraying, the efficacy of such delivery method is limited, and the particles may be non-optimally distributed over the leaf, or washed away under naturally variable climatological conditions, before the release of the agrochemical is completed. For a specific distribution and efficient retention of the microparticles, a specific, strongly binding molecule is needed that can assure that the carrier binds to the plant till its content is completely delivered.

Such microcapsules, intended for specific targeting and delivery of agrochemicals have been described in the art. In WO03031477 it is suggested to use a bifunctional fusion protein comprising a cellulose binding domain to target particles to a plant. A similar concept is disclosed in WO2004/031379, using a fusion protein comprising a carbohydrate binding domain. However, this fusion protein is linked to the particle by a non-covalent affinity binding, resulting in a rather weak retention of the particle on the plant, which may not resist the adverse conditions in the field.

U.S. Pat. No. 5,686,113 describes microcapsules prepared by a coacervation process, with peptides linked to the surface for in vivo delivery of active ingredients, however, the disclosure is limited to microcapsules with an aqueous core and is therefore of limited use for delivery of agrochemicals as the large majority of agrochemical active substances are poorly water-soluble.

U.S. Pat. No. 4,674,480 and U.S. Pat. No. 4,764,359 are disclosing targeted drug units, comprising an antibody united with or bonded to such drug unit. However, these applications do not disclose targeted particles for agrochemical applications, nor how such particles can be produced.

WO01/44301 discloses a method to immobilize VHH onto a solid surface without linker, wherein the VHH remains able to bind antigen in solution, but it is unclear whether this method can be applied to microcapsules, and if the microcapsules can be sufficiently loaded with antibodies to retain the microcapsule to a solid surface, in an agrochemical application.

Indeed, the binding affinity of the targeting agents and the resulting binding force to retain the microcapsules is critical. There is no teaching in the art about a method to produce microcapsules comprising sufficient targeting agents at their surface to ensure an efficient and specific binding that allows the retention the microcapsule to a surface, particularly to a naturally occurring surface with variable antigen density.

### SUMMARY OF THE DISCLOSURE

We have found that in order to target microcapsules of different size (up to at least φ10 μm) to natural surfaces on which the ligand density cannot be controlled requires exceptionally functional microcapsule shells and type of targeting agents. We could demonstrate that using antigen binding proteins derived from camelid antigen binding proteins in a specific targeting agent, covalently linked to microcapsules, a critical density of functional targeting agents on the surface of the microcapsule could be obtained. This critical density was not earlier disclosed, and enables an efficient and specific targeting of the microcapsules and retention to antigen-containing solid surfaces or to naturally occurring surfaces with variable antigen density, and an efficient delivery of agrochemicals, incorporated in the microcapsule.

### DEFINITIONS

The disclosure will be described with respect to particular embodiments and with reference to certain drawings but the disclosure is not limited thereto but only by the claims. Any reference signs in the claims shall not be construed as limiting the scope. The drawings described are only schematic and are non-limiting. In the drawings, the size of some of the elements may be exaggerated and not drawn on scale for illustrative purposes. Where the term “comprising” is used in the present description and claims, it does not exclude other elements or steps. Where an indefinite or definite article is used when referring to a singular noun e.g., “a” or “an,” “the,” this includes a plural of that noun unless something else is specifically stated. Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the disclosure, described herein, are capable of operation in other sequences than described or illustrated herein.

Unless otherwise defined herein, scientific and technical terms and phrases used in connection with the present disclosure shall have the meanings that are commonly understood by those of ordinary skill in the art. Generally, nomenclatures used in connection with, and techniques of molecular and cellular biology, genetics and protein and nucleic acid chemistry, described herein, are those well-known and commonly used in the art. The methods and techniques of the present disclosure are generally performed according to conventional methods well known in the art and as described in various general and more specific references that are cited and discussed throughout the present specification unless otherwise indicated. See, for example, Sambrook et al., Molecular Cloning: A Laboratory Manual, 2d ed., Cold Spring Harbor Laboratory Press, Cold Spring Harbor, N.Y. (1989); Ausubel et al., Current Protocols in Molecular Biology, Greene Publishing Associates (1992, and Supplements to 2002).

As used herein, the terms “determining,” “measuring,” “assessing,” “monitoring” and “assaying” are used interchangeably and include both quantitative and qualitative determinations.

The terms “effective amount,” “effective dose” and “effective amount,” as used herein, mean the amount needed to achieve the desired result or results.

As used herein, the terms “polypeptide,” “protein,” “peptide” are used interchangeably, and refer to a polymeric form of amino acids of any length, which can include coded and non-coded amino acids, chemically or biochemically modified or derivatized amino acids, and polypeptides having modified peptide backbones.

As used herein, the terms “complementarity determining region” or “CDR” within the context of antibodies refer to variable regions of either H (heavy) or L (light) chains (also abbreviated as VH and VL, respectively) and contains the amino acid sequences capable of specifically binding to antigenic targets. These CDR regions account for the basic specificity of the antibody for a particular antigenic determinant structure. Such regions are also referred to as “hypervariable regions.” The CDRs represent non-contiguous stretches of amino acids within the variable regions but, regardless of species, the positional locations of these critical amino acid sequences within the variable heavy and light chain regions have been found to have similar locations within the amino acid sequences of the variable chains. The variable heavy and light chains of all canonical antibodies each have 3 CDR regions, each non-contiguous with the others (termed L1, L2, L3, H1, H2, H3) for the respective light (L) and heavy (H) chains.

The term “affinity,” as used herein, refers to the degree to which a polypeptide, in particular an immunoglobulin, such as an antibody, or an immunoglobulin fragment, such as a VHH, binds to an antigen so as to shift the equilibrium of antigen and polypeptide toward the presence of a complex formed by their binding. Thus, for example, where an antigen and antibody (fragment) are combined in relatively equal concentration, an antibody (fragment) of high affinity will bind to the available antigen so as to shift the equilibrium toward high concentration of the resulting complex. The dissociation constant is commonly used to describe the affinity between the protein binding domain and the antigenic target. Typically, the dissociation constant is lower than 10⁻⁵ M. Preferably, the dissociation constant is lower than 10⁻⁶ M, more preferably, lower than 10⁻⁷ M. Most preferably, the dissociation constant is lower than 10⁻⁸ M.

A “binding site,” as used herein, means a molecular structure or compound, such as a protein, a (poly)peptide, a (poly)saccharide, a glycoprotein, a lipoprotein, a fatty acid, a lipid or a nucleic acid or a particular region in such molecular structure or compound or a particular conformation of such molecular structure or compound, or a combination or complex of such molecular structures or compounds. Preferably, the binding site comprises at least one antigen.

“Antigen,” as used herein, means a molecule capable of eliciting an immune response in an animal.

The terms “specifically bind” and “specific binding,” as used herein, generally refers to the ability of a polypeptide, in particular an immunoglobulin, such as an antibody, or an immunoglobulin fragment, such as a VHH, to preferentially bind to a particular antigen that is present in a homogeneous mixture of different antigens. In certain embodiments, a specific binding interaction will discriminate between desirable and undesirable antigens in a sample, in some embodiments more than about 10 to 100-fold or more (e.g., more than about 1000- or 10,000-fold).

“Plant,” as used herein, means live plants and live plant parts, including fresh fruit, vegetables and seeds.

“Crop,” as used herein, means a plant species or variety that is grown to be harvested as food, livestock fodder, fuel raw material, or for any other economic purpose. As a non-limiting example, the crops can be maize, cereals, such as wheat, rye, barley and oats, sorghum, rice, sugar beet and fodder beet, fruit, such as pome fruit (e.g., apples and pears), citrus fruit (e.g., oranges, lemons, limes, grapefruit, or mandarins), stone fruit (e.g., peaches, nectarines or plums), nuts (e.g., almonds or walnuts), soft fruit (e.g., cherries, strawberries, blackberries or raspberries), the plantain family or grapevines, leguminous crops, such as beans, lentils, peas and soya, oil crops, such as sunflower, safflower, rapeseed, canola, castor or olives, cucurbits, such as cucumbers, melons or pumpkins, fibre plants, such as cotton, flax or hemp, fuel crops, such as sugarcane, miscanthus or switchgrass, vegetables, such as potatoes, tomatoes, peppers, lettuce, spinach, onions, carrots, egg-plants, asparagus or cabbage, ornamentals, such as flowers (e.g., petunias, pelargoniums, roses, tulips, lilies, or chrysanthemums), shrubs, broad-leaved trees (e.g., poplars or willows) and evergreens (e.g., conifers), grasses, such as lawn, turf or forage grass or other useful plants, such as coffee, tea, tobacco, hops, pepper, rubber or latex plants.

“Microbe,” as used herein, means bacterium, virus, fungus, yeast and the like and “microbial” means derived from a microbe.

“Active substance,” as used herein, means any chemical element and its compounds, including micro-organisms, having general or specific action against harmful organisms or on plants, parts of plants or plant products, as they occur naturally or by manufacture, including any impurity inevitably resulting from the manufacturing process.

“Agrochemical,” as used herein, means any active substance that may be used in the agrochemical industry (including agriculture, horticulture, floriculture and home and garden uses, but also products intended for non-crop related uses such as public health/pest control operator uses to control undesirable insects and rodents, household uses, such as household fungicides and insecticides and agents, for protecting plants or parts of plants, crops, bulbs, tubers, fruits (e.g., from harmful organisms, diseases or pests); for controlling, preferably promoting or increasing, the growth of plants; and/or for promoting the yield of plants, crops or the parts of plants that are harvested (e.g., its fruits, flowers, seeds, etc.). Examples of such substances will be clear to the skilled person and may, for example, include compounds that are active as insecticides (e.g., contact insecticides or systemic insecticides, including insecticides for household use), herbicides (e.g., contact herbicides or systemic herbicides, including herbicides for household use), fungicides (e.g., contact fungicides or systemic fungicides, including fungicides for household use), nematicides (e.g., contact nematicides or systemic nematicides, including nematicides for household use) and other pesticides or biocides (for example, agents for killing insects or snails); as well as fertilizers; growth regulators such as plant hormones; micro-nutrients, safeners, pheromones; semiochemicals, repellants; insect baits; microbes and microbial derived products and/or active substances that are used to modulate (i.e., increase, decrease, inhibit, enhance and/or trigger) gene expression (and/or other biological or biochemical processes) in or by the targeted plant (e.g., the plant to be protected or the plant to be controlled), such as nucleic acids (e.g., single stranded or double stranded RNA, as, for example, used in the context of RNAi technology) and other factors, proteins, chemicals, etc., known per se for this purpose, etc. Examples of such agrochemicals will be clear to the skilled person; and for example include, without limitation: glyphosate, paraquat, metolachlor, acetochlor, mesotrione, 2,4-D,atrazine, glufosinate, sulfosate, fenoxaprop, pendimethalin, picloram, trifluralin, bromoxynil, clodinafop, fluroxypyr, nicosulfuron, bensulfuron, imazetapyr, dicamba, imidacloprid, thiamethoxam, fipronil, chlorpyrifos, deltamethrin, lambda-cyhalotrin, endosulfan, methamidophos, carbofuran, clothianidin, cypermethrin, abamectin, diflufenican, spinosad, indoxacarb, bifenthrin, tefluthrin, azoxystrobin, imazalil, thiamethoxam, tebuconazole, mancozeb, cyazofamid, fluazinam, pyraclostrobin, epoxiconazole, chlorothalonil, copper fungicides, trifloxystrobin, prothioconazole, difenoconazole, carbendazim, propiconazole, thiophanate, sulphur, boscalid and other known agrochemicals or any suitable combination(s) thereof.

An “agrochemical composition,” as used herein, means a composition for agrochemical use, as further defined, comprising at least one active substance, optionally with one or more additives favoring optimal dispersion, atomization, deposition, leaf wetting, distribution, retention and/or uptake of agrochemicals. As a non-limiting example, such additives are diluents, solvents, adjuvants, surfactants, wetting agents, spreading agents, oils, stickers, thickeners, penetrants, buffering agents, acidifiers, anti-settling agents, anti-freeze agents, photo-protectors, defoaming agents, biocides and/or drift control agents.

“Agrochemical use,” as used herein, not only includes the use of agrochemicals as defined above (for example, pesticides, growth regulators, nutrients/fertilizers, repellants, defoliants, etc.) that are suitable and/or intended for use in field grown crops (e.g., agriculture), but also includes the use of agrochemicals as defined above (for example, pesticides, growth regulators, nutrients/fertilizers, repellants, defoliants, etc.) that are meant for use in greenhouse grown crops (e.g., horticulture/floriculture) or hydroponic culture systems and even the use of agrochemicals as defined above that are suitable and/or intended for non-crop uses such as uses in private gardens, household uses (for example, herbicides or insecticides for household use), or uses by pest control operators (for example, weed control, etc.).

“Polyfunctional monomers,” as used herein, means monomeric components with functionalities greater than 2 that can be converted by chemical reaction into polymers. Examples of such polyfunctional monomers include, but are not limited to, TDI (toluene diisocyanate) and PMPPI (Polymethylene polyphenyl isocyanate).

“Prepolymers,” as used herein, means partially polymerized polyfunctional monomers, containing at least one free reactive group, which when added to a prepolymer-reactant component will participate in the further polymerization reaction.

“Monomer- or prepolymer-reactant component,” as used herein, means a component containing reactive groups, for example hydroxyl-, amine- and/or thiol-groups such that it can participate in a chemical reaction with the polyfunctional monomers or prepolymers.

“Anchor groups,” as used herein, means parts of chemical compounds that have such properties that (poly)peptides can be bound covalently thereon. Examples of such anchor groups include carboxyl-, amine-, aldehyde-, hydroxyl-, sulfhydryl-, terminal alkyne-, diene, dienophile and azide groups.

A “targeting agent,” as used herein, is a molecular structure, preferably with a polypeptide backbone, comprising at least one antigen binding protein. A targeting agent in its simplest form consists solely of one single antigen binding protein; however, a targeting agent can comprise more than one antigen binding protein and can be monovalent or multivalent and monospecific or multispecific, as further defined. Apart from one single or multiple antigen binding proteins, a targeting agent can further comprise other moieties, which can be either chemically coupled or fused, whether N-terminally or C-terminally or even internally fused, to the binding protein. The other moieties include, without limitation, one or more amino acids, including labeled amino acids (e.g., fluorescently or radio-actively labeled) or detectable amino acids (e.g., detectable by an antibody), one or more monosaccharides, one or more oligosaccharides, one or more polysaccharides, one or more lipids, one or more fatty acids, one or more small molecules or any combination of the foregoing. In one preferred embodiment, the other moieties function as spacers or linkers in the targeting agent.

An “antigen binding protein,” as used herein, means the whole or part of a proteinaceous (protein, protein-like or protein containing) molecule that is capable of binding using specific intermolecular interactions to a target molecule. An antigen binding protein can be a naturally occurring molecule, it can be derived from a naturally occurring molecule, or it can be entirely artificially designed. An antigen binding protein can be immunoglobulin-based or it can be based on domains present in proteins, including but not limited to microbial proteins, protease inhibitors, toxins, fibronectin, lipocalins, single chain antiparallel coiled coil proteins or repeat motif proteins. Non-limiting examples of such antigen binding proteins are carbohydrate antigen binding proteins (CBD) (Blake et al., 2006), heavy chain antibodies (hcAb), single domain antibodies (sdAb), minibodies (Tramontano et al., 1994), the variable domain of camelid heavy chain antibodies (VHH), the variable domain of the new antigen receptors (VNAR), affibodies (Nygren et al., 2008), alphabodies (WO2010066740), designed ankyrin-repeat domains (DARPins) (Stumpp et al., 2008), anticalins (Skerra et al., 2008), knottins (Kolmar et al., 2008) and engineered CH2 domains (nanoantibodies; Dimitrov, 2009).

A “microcapsule,” as used herein, is a microcarrier, consisting of an inner liquid core, preferably containing one or more agrochemicals, more preferably active substances, surrounded by a solid wall or shell.

A “microcarrier,” as used herein, means a particulate carrier where the particles are less than 500 μm in diameter, preferably less than 250 μm, even more preferable less than 100 μm, still more preferably less than 50 μm, most preferably less than 20 μm.

A “carrier,” as used herein, means any solid, semi-solid or liquid carrier in or on(to) which an active substance can be suitably incorporated, included, immobilized, adsorbed, absorbed, bound, encapsulated, embedded, attached, or comprised. Non-limiting examples of such carriers include nanocapsules, microcapsules, nanospheres, microspheres, nanoparticles, microparticles, liposomes, vesicles, beads, a gel, weak ionic resin particles, liposomes, cochleate delivery vehicles, small granules, granulates, nano-tubes, bucky-balls, water droplets that are part of an water-in-oil emulsion, oil droplets that are part of an oil-in-water emulsion, organic materials such as cork, wood or other plant-derived materials (e.g., in the form of seed shells, wood chips, pulp, spheres, beads, sheets or any other suitable form), paper or cardboard, inorganic materials such as talc, clay, microcrystalline cellulose, silica, alumina, silicates and zeolites, or even microbial cells (such as yeast cells) or suitable fractions or fragments thereof.

A “linking agent,” as used herein, may be any linking agent known to the person skilled in the art; that allows attaching of targeting agents, preferably by covalent linking, to the microcapsule surface, such as, but not limited to, EDC (1-Ethyl-3-[3-dimethylaminopropyl]carbodiimide hydrochloride) or the homobifunctional cross-linker ((bis[sulfosuccinimidyl]suberate) (BS3).

“Specifically targeting microcapsule,” as used herein, means that the microcapsule can bind specifically to a binding site on a solid surface, through the antigen binding proteins comprised in the targeting agents present at the microcapsule surface.

“Retain,” as used herein, means that the binding force resulting from the affinity or avidity of either one single binding protein or a combination of two or more binding proteins or targeting agents comprising antigen binding proteins for its or their target molecule present at the solid surface is larger than the combined force and torque imposed by the gravity of the carrier, and the force and torque, if any, imposed by shear forces caused by one or more external factors.

“VHH,” as used herein, means the variable domain of heavy chain camelid antibodies, devoid of light chains.

A first aspect of the disclosure is a process for manufacturing a specifically targeting microcapsule, the process comprising at least the steps of:
a. Emulsifying into a continuous aqueous phase, the aqueous phase optionally comprising a surfactant, an organic phase in which a to be encapsulated agrochemical or combination of agrochemicals, optionally together with polyfunctional monomers or prepolymers, are dissolved or dispersed to form an emulsion of droplets of the organic phase in the continuous aqueous phase;
b. Causing an aqueous suspension of microcapsules with polymer walls having anchor groups at their surface to be formed; and
c. Covalently linking at least one targeting agent to the anchor groups at the microcapsule surface, at a ratio from about 0.01 μg to about 1 μg targeting agent per square cm microcapsule surface

In one preferred embodiment, the process comprises the steps of:
a. Emulsifying into a continuous aqueous phase, the aqueous phase optionally comprising a surfactant, an organic phase in which a to be encapsulated agrochemical or combination of agrochemicals together with polyfunctional monomers or prepolymers are dissolved or dispersed to form an emulsion of droplets of the organic phase in the continuous aqueous phase;
b. Optionally adding to the emulsion a monomer- or prepolymer-reactant component containing anchor groups;
c. Causing polymerization of the monomers or prepolymers to form an aqueous suspension of microcapsules with polymer walls having anchor groups at their surface; and
d. Covalently linking at least one targeting agent to the anchor groups at the microcapsule surface, at a ratio from about 0.01 μg to about 1 μg targeting agent per square cm microcapsule surface.

The organic phase is preferably substantially water-immiscible, meaning that the solubility of the organic phase in the aqueous phase is less than 10% by weight, preferably less than 5%, more preferably less than 1%, even more preferably less than 0.5%. The substantially water-immiscible organic phase consists preferably of a non-polar solvent that does not interfere with the encapsulation reaction, in which the polyfunctional monomers or prepolymers, together with the agrochemicals to be encapsulated can be dissolved or dispersed. Suitable solvents include hydrocarbon solvents, such as kerosene, and alkyl benzenes, such as toluene, xylene, benzyl benzoate, diisopropyl naphthalene, Norpar 15, Exxsol D110 and D130, Orchex 692, Suresol 330, Aromatic 200, Citroflex A-4 and diethyl adipate.

Suitable polyfunctional monomers include dicarboxylic acid chlorides, bis(chlorocarbonates), bis(sulfonylchlorides), trifunctional adducts of linear aliphatic isocyanates, such as hexamethylene 1,6-diisocyanate, 1,4-cyclohexane diisocyanate, triethyl-hexamethylene diisocyanate, trimethylenediisocyanate, propylene-1,2-diisocyanate, butylene-1,2-diisocyanate, isophorone diisocyanate, Desmodur N3200, Desmodur N3300, Desmodur W, Tolonate HDB, Tolonate HDT, or isocyanates containing at least one aromatic moiety are used as monomers, such as methylene-bis-diphenyldiisocyanate (‘MDI’), polymeric methylene-bis-diphenyldiisocyanate, polymethylenepolyphenyleneisocyanate (‘PMPP1’) or 2,4- and 2,6-toluene diisocyanate (‘TDI’), naphthalene diisocyanate, diphenylmethane diisocyanate and triphenylmethane-p,p′,p″-trityl triisocyanate.

Prepolymers can be prepared by polymerizing as a non-limiting example one or more polyisocyanates with one or more organic components having at least one isocyanate reactive hydrogen atom, such as a polyol or a polyamine.

Preferably, the aqueous phase comprises a surfactant to stabilize the formed emulsion. The surfactant may be ionic or non-ionic. Examples of suitable ionic surfactants include sodium dodecylsulphate, sodium or potassium polyacrylate or sodium or potassium polymethacrylate. Examples of suitable non-ionic surfactants include polyvinlyalcohol (‘PVA’), polyvinlypyrrolidone (‘PVP’), poly(ethoxy)nonylphenol, polyether block copolymers, such as Pluronic and Tetronic, polyoxyethylene adducts of fatty alcohols, such as Brij surfactants, esters of fatty acids, such as sorbitan monostearate, sorbitan monooleate, Tween-20 (Polyoxyethylene (20) sorbitan monolaurate), Tween-80 (Polyoxyethylene (80) sorbitan monooleate), sorbitan sesquioleate or Arlacel C surfactants. The quantity of surfactant is not critical but for convenience generally comprises from about 0.05% to about 10% by weight of the aqueous phase.

It will be clear to the person skilled in the art how the organic phase can be emulsified in the aqueous phase. Suitable emulsification techniques include homogenization by any type of agitation, but may also be performed using micro-sieving techniques. Emulsification of the organic phase in the aqueous phase is preferably done by high shear agitation. The agitation rate determines the droplet size of the emulsion. Typical initial agitation rates are from about 5000 rpm to about 20000 rpm, more preferably from about 75000 rpm to about 15000 rpm. The agitation is preferably slowed down prior to addition of the monomer- or prepolymer-reactant components to a stirring rate of about 100 rpm to 1000 rpm, more preferably from about 200 rpm to about 500 rpm.

Preferably, as soon as possible after the emulsion has been prepared, the monomer- or prepolymer-reactant components are added to the aqueous phase. In their simplest form, the monomer- or prepolymer-reactant components consist of water and are already present in the aqueous phase, in which case the interfacial polymerization reaction is initiated by hydrolysis of the polyfunctional monomers. In a preferred embodiment, however, monomer- or prepolymer-reactant components comprising anchor groups are added to the aqueous phase. In order to be reactive with the polyfunctional monomers or prepolymers, the reactant components comprise preferably amine, hydroxyl and/or thiol groups. The monomer- or prepolymer-reactant components, according to the disclosure, comprise at least one anchor group and at least one, preferably more reactive groups which reacts during the polymerization process with one of the polyfunctional monomers or prepolymers. In a preferred embodiment, the anchor group does not react during the polymerization process with one of the other reaction components. In another preferred embodiment, the monomer- or prepolymer-reactant component comprises at least two reactive groups which react during the polymerization process with the polyfunctional monomers or prepolymers. In this way larger amounts of the monomer- or prepolymer reactant component can be used since it does not act as a chain terminator but instead as a chain extender or cross-linker. Suitable examples of such monomer- or prepolymer reactant components, comprise tetraethylene-pentamine (TEPA), pentamethylene hexamine, lysine, dipeptides, including H-Lys-Glu-OH, H-Asp-Lys-OH, H-Lys-Asp-OH, H-Glu-Lys-OH, H-Glu-Asp-OH, propargylethanol, propargylamine, N-propargyldiethanolamine, 2,2-di(prop-2-ynyl)propane-1,3 diol (DPPD), 1-(propargyloxy)benzene-3,5-methanol (PBM), N-propargyldipropanol-amine, 2-propargyl propane-1,3-diol, (2-methyl-2-propargyl)propane-diol.

One type of monomer- or prepolymer reactant components can be used in the process, according to the disclosure, or a blend of at least two, optionally more than two, monomer- or prepolymer reactant components can be added. In a preferred embodiment, cross-linkers, such as tri-, tetra- or pentamines, are added to strengthen the microcapsule wall.

Alternative methods for presenting anchor groups at the surface of a microcapsule are known to the person skilled in the art, and have been disclosed, amongst others, by Mason et al., 2009 and in U.S. Pat. No. 5,011,885 and U.S. Pat. No. 6,022,501, incorporated herein by reference.

The reaction proceeds readily at room temperature, but it may be advantageous to operate at elevated temperatures, at about 40° C. to about 70° C., preferably at about 50° C. to about 60° C., it may as well be advantageous to operate at slightly decreased temperatures, preferably at about 15° C.

In the finishing step of the process, at least one targeting agent is covalently linked to the anchor groups at the microcapsule surface, at a ratio from about 0.01 μg to about 1 μg targeting agent per square cm microcapsule surface.

It will be clear to the person skilled in the art how a targeting agent can be covalently linked to anchor groups present at the microcapsules surface. Methods for linking proteinaceous molecules to carboxyl or amine anchor groups have been extensively described such as in Bioconjugate techniques, 2nd Edition, Greg T. Hermanson.

In one preferred embodiment, such covalent linking is performed using carbodiimide chemistry, by forming of a carbodiimide bond between the anchor groups at the surface of the microcapsule and reactant groups in the targeting agent, as a non-limiting example between carboxylgroups on the outer surface of the microcapsule and amine-groups of the antigen binding protein comprised in the targeting agent. Such covalent linking may be effectuated in a one-step reaction, in which all reaction components are added simultaneously, or it may be performed in a two-step reaction, in which either the anchor group on the microcapsule surface or the targeting agent is first activated into a highly reactive intermediate product, after which the other reaction components are added. Optionally, an additional stabilizing agent, such as N-hydroxysuccinimide (NHS) or N-hydroxysulfosuccinimide (sulfo-NHS), may be added to the reaction to stabilize the highly reactive intermediate product and increase the reaction efficiency.

In another preferred embodiment, the targeting agent is covalently bound to the anchor groups on the microcapsule surface using “click chemistry,” as defined by Sharpless in Angew. Chem. Int. Ed. 2001, 40, 2004. In this preferred embodiment, the anchor groups are reactive unsaturated groups which do not react during the polymerization process and are preferably selected from the group consisting of a terminal alkyne and an azide, which are able to participate in a Huisgen 1,3-dipolar cycloaddition reaction, or from the group consisting of a diene and a dienophile, which are able to participate in a Diels-Alder cycloaddition reaction.

Targeting agents or the antigen binding proteins comprised therein can be coupled with or without linking agents to the microcapsules. A “linking agent,” as used here, may be any linking agent known to the person skilled in the art; that allows covalent linking of targeting agents or the antigen binding protein comprised in the targeting agent to the anchor groups at the microcapsule surface, such as, but not limited to, EDC (1-Ethyl-3-[3-dimethylaminopropyl]carbodiimide hydrochloride) or the homobifunctional cross-linker ((bis[sulfosuccinimidyl]suberate) (BS3). The linking agent can be such that it results in the incorporation of a spacer between the targeting agent and the microcapsule surface, in order to increase the flexibility of the targeting agent bound to the microcapsule and thereby facilitating the binding of the antigen binding protein comprised in the targeting agent to its target molecule on the solid surface. Examples of such spacers can be found in WO0024884 and WO0140310. In a preferred embodiment, the linking agent, however, results in a direct covalent binding of the targeting agent to the microcapsule surface, without the incorporation of a spacer.

In a preferred embodiment, the method for covalently linking at least one targeting agent, or an antigen binding protein comprised in a targeting agent, using a linking agent to an anchor group on the microcapsule surface, comprises the steps of:
reacting a linking agent with the targeting agent; and
reacting the microcapsule to the linking agent in a ratio in a ratio from about 0.01 μg to about 1 μg targeting agent per square cm microcapsule surface.

In another preferred embodiment, the method for covalently linking at least one targeting agent, or an antigen binding protein comprised in a targeting agent, using a linking agent to an anchor group on the microcapsule surface, comprises the steps of:

reacting the microcapsule with a linking agent; and
reacting targeting agents with the linking agent in a ratio from about 0.01 μg to about 1 μg targeting agent per square cm microcapsule surface.

In one embodiment, at least one targeting agent is covalently linked to the anchor groups at the microcapsule surface at a ratio from about 0.01 μg to about 1 μg per square cm microcapsule surface.

In more specific embodiments, at least one targeting agent is covalently linked to the anchor groups at the microcapsule surface at a ratio from 0.01 μg to 0.05 μg, from 0.01 μg to 0.1 μg, from 0.01 μg to 0.2 μg, from 0.01 μg to 0.3 μg, from 0.01 μg to 0.4 μg, from 0.01 μg to 0.5 μg, from 0.01 μs to 0.6 μg, from 0.01 μg to 0.7 μg, from 0.01 μg to 0.8 μg, from 0.01 μg to 0.9 μg, from 0.01 μs to 1 μg per square cm of microcapsule surface.

In yet another embodiment, at least one targeting agent is covalently linked to the anchor groups at the microcapsule surface at a ratio from 0.05 μs to 0.1 μg, from 0.05 μg to 0.2 μg, from 0.05 μg to 0.3 μg, from 0.05 μg to 0.4 μg, from 0.05 μg to 0.5 μg, from 0.05 μg to 0.6 μg, from 0.05 μg to 0.7 μg, from 0.05 μg to 0.8 μg, from 0.05 μg to 0.9 μg, from 0.05 μg to 1 μg per square cm of microcapsule surface.

In yet another embodiment, at least one targeting agent is covalently linked to the anchor groups at the microcapsule surface at a ratio from 0.1 μg to 0.2 μg, from 0.1 μg to 0.3 μg, from 0.1 μg to 0.4 μg, from 0.1 μg to 0.5 μg, from 0.1 μg to 0.6 μg, from 0.1 μg to 0.7 μg, from 0.1 μg to 0.8 μg, from 0.1 μg to 0.9 μg, from 0.1 μg to 1 μg per square cm of microcapsule surface.

In yet another embodiment, at least one targeting agent is covalently linked to the anchor groups at the microcapsule surface at a ratio from 0.2 μg to 0.3 μg, from 0.2 μs to 0.4 μg, from 0.2 μg to 0.5 μg, from 0.2 μg to 0.6 μg, from 0.2 μg to 0.7 μg, from 0.2 μg to 0.8 μg, from 0.2 μg to 0.9 μs, from 0.2 μg to 1 μg per square cm of microcapsule surface.

In yet another embodiment, at least one targeting agent is covalently linked to the anchor groups at the microcapsule surface at a ratio from 0.3 μs to 0.4 μg, from 0.3 μg to 0.5 μg, from 0.3 μg to 0.6 μg, from 0.3 μs to 0.7 μg, from 0.3 μg to 0.8 μg, from 0.3 μg to 0.9 μg, from 0.3 μg to 1 μg per square cm of microcapsule surface.

In yet another embodiment, at least one targeting agent is covalently linked to the anchor groups at the microcapsule surface at a ratio from 0.4 μg to 0.5 μg, from 0.4 μg to 0.6 μg, from 0.4 μs to 0.7 μg, from 0.4 μg to 0.8 μg, from 0.4 μg to 0.9 μs, from 0.4 μg to 1 μg per square cm of microcapsule surface.

In yet another embodiment, at least one targeting agent is covalently linked to the anchor groups at the microcapsule surface at a ratio from 0.5 μg to 0.6 μg, from 0.5 μg to 0.7 μg, from 0.5 μg to 0.8 μg, from 0.5 μg to 0.9 μg, from 0.5 μg to 1 μg per square cm of microcapsule surface.

In yet another embodiment, at least one targeting agent is covalently linked to the anchor groups at the microcapsule surface at a ratio from 0.6 μg to 0.7 μg, from 0.6 μg to 0.8 μg, from 0.6 μg to 0.9 μg, from 0.6 μg to 1 μg per square cm of microcapsule surface.

In yet another embodiment, at least one targeting agent is covalently linked to the anchor groups at the microcapsule surface at a ratio from 0.7 μg to 0.8 μg, from 0.7 μg to 0.9 μg, from 0.7 μg to 1 μg per square cm of microcapsule surface.

In yet another embodiment, at least one targeting agent is covalently linked to the anchor groups at the microcapsule surface at a ratio from 0.8 μg to 0.9 μg, from 0.8 μg to 1 μg per square cm of microcapsule surface.

In yet another embodiment, at least one targeting agent is covalently linked to the anchor groups at the microcapsule surface at a ratio from 0.9 μg to 1 μg per square cm of microcapsule surface.

The targeting agent covalently linked to the specifically targeting microcapsules, according to the disclosure, may either be a “mono-specific” targeting agent or a “multi-specific” targeting agent. By a “mono-specific” targeting agent is meant a targeting agent that comprises either a single antigen binding protein, or that comprises two or more different antigen binding proteins that each are directed against the same binding site. Thus, a mono-specific targeting agent is capable of binding to a single binding site, either through a single antigen binding protein or through multiple antigen binding proteins. By a “multi-specific” targeting agent is meant a targeting agent that comprises two or more antigen binding proteins that are each directed against different binding sites. Thus, a “bi-specific” targeting agent is capable of binding to two different binding sites; a “tri-specific” targeting agent is capable of binding to three different binding sites; and so on for “multi-specific” targeting agents. Also, in respect of the targeting agents described herein, the “monovalent” is used to indicate that the targeting agent comprises a single antigen binding protein; the term “bivalent” is used to indicate that the targeting agent comprises a total of two single antigen binding proteins; the term “trivalent” is used to indicate that the targeting agent comprises a total of three single antigen binding proteins; and so on for “multivalent” targeting agents.

Preferably, the antigen binding proteins comprised in the targeting agents of the disclosure are monoclonal antigen binding proteins. A “monoclonal antigen binding protein,” as used herein, means an antigen binding protein produced by a single clone of cells and therefore a single pure homogeneous type of antigen binding protein. More preferably, the antigen binding proteins comprised in the targeting agents of the disclosure consist of a single polypeptide chain. Most preferably, the antigen binding proteins comprised in the targeting agents of the disclosure comprise an amino acid sequence that comprises 4 framework regions and 3 complementary determining regions, or any suitable fragment thereof, and confer their binding specificity by the amino acid sequence of 3 complementary determining regions or CDRs, each non-contiguous with the others (termed CDR1, CDR2, CDR3), which are interspersed amongst 4 framework regions or FRs, each non-contiguous with the others (termed FR1, FR2, FR3, FR4), preferably in a sequence FR1-CDR1-FR2-CDR2-FR3-CDR3-FR4). The delineation of the FR and CDR sequences is based on the unique numbering system according to Kabat. The antigen binding proteins comprising an amino acid sequence that comprises 4 framework regions and 3 complementary determining regions, are known to the person skilled in the art and have been described, as a non-limiting example in Wesolowski et al., (2009). The length of the CDR3 loop is strongly variable and can vary from 0, preferably from 1, to more than 20 amino acid residues, preferably up to 25 amino acid residues. Preferably, the antigen binding proteins are derived from camelid antibodies, preferably from heavy chain camelid antibodies, devoid of light chains, such as variable domains of heavy chain camelid antibodies (VHH). Those antibodies are easy to produce, and are far more stable than classical antibodies, which provides a clear advantage for stable binding to naturally occurring surfaces under conditions that deviate substantially from physiological conditions, such as changes in temperature, availability of water or moisture, presence of detergents, extreme pH or salt concentration. For each of these variables VHH are stable and often can exert binding in conditions that are considered extreme.

In a preferred embodiment, the targeting agent consists of a VHH, which is either C-terminally or N-terminally or even internally fused with one or more amino acids, such as lysines, in order to increase functionality of the targeting agent when covalently linked to the anchor groups on the surface of the microcapsule.

In another preferred embodiment, the process comprises the steps of:
a. Emulsifying into a continuous aqueous phase, the aqueous phase optionally comprising a surfactant, an organic phase in which a to be encapsulated agrochemical or combination of agrochemicals, together with a prepolymer or mixture of prepolymers containing anchor groups, is dissolved or dispersed to form an emulsion of droplets of the organic phase in the continuous aqueous phase;
b. Causing in situ self-condensation of the prepolymers surrounding the droplets of organic phase to form an aqueous suspension of microcapsules having polymer walls with anchor groups at their surface; and
c. Covalently linking at least one targeting agent to the anchor groups at the microcapsule surface, at a ratio from about 0.01 μg to about 1 μg targeting agent per square cm microcapsule surface.

Amino resin prepolymers of the urea-formaldehyde, melamine-formaldehyde, benzoguanamine-formaldehyde or glycoluril-formaldehyde type, with a high solubility in the organic phase and a low solubility in the aqueous phase are suitable in the process. To impart solubility in the organic phase, the amino resin prepolymers are partially etherified, meaning that they have the hydroxyl hydrogen atoms replaced by alkyl groups. Partially etherified amino resin prepolymers are obtained by condensation of the prepolymer with an alcohol. The amino resin prepolymers can be prepared by techniques well known to the person skilled in the art, such as by the reaction between the amine, preferably urea or melamine, formaldehyde and alcohol. The organic phase may further contain solvents and polymerization catalysts, such as sulphonic acid surfactant catalysts.

The amount of the prepolymer in the organic phase is not critical and can vary over a wide range depending on the desired capsule wall strength and the desired quantity of core material in the finished microcapsule. In a preferred embodiment, the organic phase comprises a prepolymer concentration from about 1% to about 70% on a weight basis, more preferably from about 5% to about 50%.

Once the organic phase has been formed, an emulsion is then prepared by emulsifying the organic phase in an aqueous phase, optionally containing a surfactant. The emulsion is preferably prepared employing any suitable high shear stirring device. The stirring rate determines the size of the emulsion droplet size. The relative quantities of organic and aqueous phases are not critical to the practice of this disclosure, and can vary over a wide range, determined most by convenience and ease of handling. In practical usage, the organic phase will comprise a maximum of about 55% of the total emulsion and will consist of discrete droplets of organic phase dispersed in the aqueous phase. Once the desired droplet size is obtained, mild agitation is sufficient to maintain a stable emulsion and to proceed to the curing of the microcapsules: hereto, the emulsion is acidified to a pH between about 1 to about 4, preferably between about 1 to about 3. This causes the prepolymers to polymerize by in situ self-condensation and form a polymer wall completely enclosing each droplet. Acidification can be accomplished by any suitable means including any water-soluble acid such as formic, citric, hydrochloric, sulfuric, or phosphoric acid and the like. The rate of the in situ self-condensation increases with both acidity and temperature. The reaction can therefore be conducted from about 20° C. to about 100° C., preferably from about 40° C. to about 70° C., most preferably from about 40° C. to about 60° C.

In the finishing step of the process, at least one targeting agent is covalently linked to the anchor groups at the microcapsule surface, at a ratio from about 0.01 μg to about 1 μg targeting agent per square cm microcapsule surface, as described above.

In yet another preferred embodiment, the process comprises the steps of:
a. Emulsifying into a continuous aqueous phase, the aqueous phase optionally comprising a surfactant, an organic phase in which a to be encapsulated agrochemical or combination of agrochemicals is dissolved or dispersed to form an emulsion of droplets of the organic phase in the continuous aqueous phase;
b. Adding to the continuous aqueous phase a water-soluble prepolymer or mixture of prepolymers, containing anchor groups;
c. Causing in situ self-condensation of the prepolymers surrounding the droplets of organic phase to form an aqueous suspension of microcapsules having polymer walls with anchor groups at their surface; and
d. Covalently linking at least one targeting agent to the anchor groups at the microcapsule surface, at a ratio from about 0.01 μg to about 1 μg targeting agent per square cm microcapsule surface.

The organic phase, in which the to be encapsulated agrochemicals or combination of agrochemicals are dissolved or dispersed, is substantially water-immiscible, as described above. Once the organic phase has been formed, an emulsion is then prepared by emulsifying the organic phase in an aqueous phase, optionally containing a surfactant. The emulsion is preferably prepared employing any suitable high shear stirring device. The stirring rate determines the size of the emulsion droplet size. The relative quantities of organic and aqueous phases are not critical to the practice of this disclosure, and can vary over a wide range, determined most by convenience and ease of handling. In practical usage, the organic phase will comprise a maximum of about 55% of the total emulsion and will consist of discrete droplets of organic phase dispersed in the aqueous phase. Once the desired droplet size is obtained, mild agitation is sufficient to maintain a stable emulsion.

In a next step of the process, a water-soluble prepolymer or a mixture of water-soluble prepolymers, containing anchor groups are added to the aqueous phase. Amino resin prepolymers of the urea-formaldehyde, melamine-formaldehyde, benzoguanamine-formaldehyde or glycoluril-formaldehyde type, with a high solubility in the aqueous phase and a low solubility in the organic phase are suitable in the process. Such amino resin prepolymers can be prepared by techniques well known to the person skilled in the art, such as by the reaction between the amine, preferably urea or melamine, and formaldehyde. Preferably the anchor groups are free amine, hydroxyl or aldehyde-groups. The aqueous phase may further contain polymerization catalysts.

The amount of the prepolymer in the aqueous phase is not critical and can vary over a wide range depending on the desired capsule wall strength and the desired quantity of core material in the finished microcapsule. In a preferred embodiment, the organic phase comprises a prepolymer concentration from about 1% to about 70% on a weight basis, more preferably from about 5% to about 50%.

To proceed to the curing of the microcapsules, the emulsion is acidified to a pH between about 1 to about 4, preferably between about 1 to about 3. This causes the prepolymers to polymerize by in situ self-condensation and form a polymer wall containing anchor groups completely enclosing each droplet. Acidification can be accomplished by any suitable means including any water-soluble acid such as formic, citric, hydrochloric, sulfuric, or phosphoric acid and the like. The rate of the in situ self-condensation increases with both acidity and temperature. The reaction can therefore be conducted from about 20° C. to about 100° C., preferably from about 40° C. to about 70° C., most preferably from about 40° C. to about 60° C.

In the finishing step of the process, at least one targeting agent is covalently linked to the anchor groups at the microcapsule surface, at a ratio from about 0.01 μg to about 1 μs targeting agent per square cm microcapsule surface, as described above.

Preferred agrochemicals to be encapsulated into specifically targeting microcapsules utilizing the process, according to the disclosure, include fungicides, insecticides, herbicides, nematicides, acaricides, bactericides, pheromones, repellants, plant and insect growth regulators and fertilizers. Optionally, included with the agrochemical or combination of agrochemicals may be additives typically used in conjunction with agrochemicals such as synergists, safeners, photodegradation inhibitors, adjuvants and the like.

The concentration of the agrochemical or combination of agrochemicals in the resultant microcapsule suspension is dependent on the physical properties of the agrochemical(s). When the agrochemical(s) can be dissolved in the organic phase, the concentration of agrochemical(s) in the microcapsule suspension may range from about 2.5% to about 70% on a weight basis, more preferably from about 20% to about 70%, most preferably from about 40% to about 70% on a weight basis. In the event the agrochemical(s) need to be dispersed in the organic phase, the concentration of agrochemical(s) in the microcapsule suspension may range from about 2.5% to about 50% on a weight basis, more preferably from about 5% to about 30%, most preferably from about 10% to about 20% on a weight basis.

The process so described, with its preferred embodiments, may be performed as a continuous process or it may be performed as a batch-type of manufacturing process.

The resulting specifically targeting microcapsules have a specific gravity of less than 1 and remain suspended or dispersed in the aqueous phase. The suspension of specifically targeting microcapsules thus produced may be utilized as such, and may be packaged as capsule suspension to be used by transferring the capsules suspension into a spray tank, in which it is mixed with water to form a sprayable suspension. Alternatively, the suspension of specifically targeting microcapsules may be converted into a dry microcapsule product by spray drying or other techniques well-known to the person skilled in the art and the resulting material may be packaged in dry form.

A second aspect of the disclosure is a specifically targeting microcapsule, produced according to the process of the disclosure.

A “specifically targeting microcapsule,” as used herein, means that the microcapsule can bind specifically to a binding site on a solid surface, preferably a naturally occurring surface, through the antigen binding proteins comprised in the targeting agents present at the microcapsule surface. Specific binding means that the antigen binding protein preferentially binds to its target molecule that is present in a homogeneous or heterogeneous mixture of different other molecules. Specificity of binding of an antigen binding protein can be analyzed by methods such as ELISA, as described in examples 7-10, in which the binding of the specifically targeting microcapsule to a surface displaying its target molecule is compared with the binding of the specifically targeting microcapsule to a surface displaying an unrelated molecule and with a specific sticking of the specifically targeting microcapsule to the reaction vessel. In certain embodiments, a specific binding interaction will discriminate between desirable and undesirable target molecules on a surface, in preferred embodiments, binding to the desirable target molecule is more than one order of magnitude stronger than to undesirable target molecules, in even more preferred embodiments, binding to the desirable target molecule is more than two orders of magnitude stronger than to undesirable target molecules.

Release of the agrochemical from the specifically targeting microcapsule can be achieved in several ways:

By collapse or rupture of the microcapsule wall after dry-down of the spray deposit;
By mechanical rupture, e.g., by crawling or feeding of an insect;
By degradation of the microcapsule wall under influence of, e.g., light, heat or pH;
By diffusion of the agrochemical through the microcapsule wall.

The release rate by a diffusional mechanism is shown in the equation below, as defined by Scher et al., 1998:

$$\frac{Release rate}{{r}_{0} - {r}_{i}} = ( 4 π {r}_{o} {r}_{i} ) P ( {C}_{i} - {C}_{o} ) with P = K . D$$

whereby
r=radius; rₒ=outer radius; rᵢ=inner radius of the microcapsule
P=Permeability
K=Solubility coefficient
D=Diffusion coefficient
C=concentration of agrochemical; Cₒ=concentration outside microcapsule; Cᵢ=concentration inside microcapsule

It will be clear to the person skilled in the art that since the release rate is directly proportional to the surface area, permeability and concentration gradient across the microcapsule wall and inversely proportional to microcapsule wall thickness, the release rate can be modified by varying microcapsule size (and hence surface area), microcapsule wall thickness and the permeability of the microcapsule wall, which is defined as the product of the diffusion coefficient and the solubility coefficient. The size of the microcapsules is determined by the droplet size of the emulsion of the organic phase in the aqueous phase and can be determined by varying the rate of the high shear agitation when preparing the emulsion, whereby the higher the agitation rate, the smaller is the size of the resulting microcapsules. The ratio of the weight of the shell materials versus the weight of the core material, will, in combination with the size of the resultant microcapsules, determine the shell thickness. For a certain agrochemical, the diffusion coefficient can be varied by varying the cross-linking density of the microcapsule wall and the solubility coefficient can be varied by varying the chemical composition of the microcapsule wall.

Preferably, the specifically targeting microcapsules are such that they have immediate, delayed, gradual, triggered or slow release characteristics, for example, over several minutes, several hours, several days or several weeks. Also, the microcapsules may be made of polymer materials that rupture or slowly degrade (for example, due to prolonged exposure to high or low temperature, high or low pH, sunlight, high or low humidity or other environmental factors or conditions) over time (e.g., over minutes, hours, days or weeks) or that rupture or degrade when triggered by particular external factors (such as high or low temperature, high or low pH, high or low humidity or other environmental factors or conditions) and so release the content from the microcapsule.

Preferably, the weight ratio of shell materials versus the weight of the core material is about 3% to 30%, more preferably the weight ratio of shell materials versus the weight of the core material is about 5% to 20%, still more preferably, the weight ratio of shell materials versus the weight of the core material is about 5% to 15%.

In one preferred embodiment, the microcapsule wall is composed of polyurea, polyurethane, urea/formaldehyde or melamine/formaldehyde, containing anchor groups, most preferably the microcapsule wall is composed of polyurea containing anchor groups.

The size distribution of the specifically targeting microcapsules can be measured with a laser light scattering particle size analyzer, whereby the diameter data is preferably reported as a volume distribution (D[4.3]). Thus, the reported mean for a population of microcapsules will be volume-weighted, with about one-half of the microcapsules, on a volume basis, having diameters less than the mean diameter for the population. Preferably, the volume-weighted mean diameter of the specifically targeting microcapsules manufactured, according to the process of the disclosure, is less than about 20 microns with at least 90%, on a volume basis, of the microcapsules having a diameter less than about 60 microns. More preferably, the volume-weighted mean diameter of the specifically targeting microcapsules is between about 2 and about 10 microns with at least 90%, on a volume basis, of the microcapsules having a diameter less than about 40 microns. Even more preferably, the volume-weighted mean diameter of the specifically targeting microcapsules is between about 2 and about 5 microns with at least 90%, on a volume basis, of the microcapsules having a diameter less than about 20 microns.

The specifically targeting microcapsules have a spherical shape, their outer surface may vary from a completely smooth to a slightly rough appearance as observable under scanning electron microscopy (SEM).

The zeta-potential of the specifically targeting microcapsules may differ from the zeta-potential of comparable microcapsules, prepared without anchor groups at their surface and/or without targeting agents covalently linked thereto (Ni et al., 1995). In a preferred embodiment, the zeta-potential of the specifically targeting microcapsules is higher than the zeta-potential of comparable microcapsules, prepared without anchor groups at their surface and/or without targeting agents covalently linked thereto.

In a preferred embodiment of the disclosure, the specifically targeting microcapsules are capable of binding an agrochemical or combination of agrochemicals to a surface. The surface may be any surface, known to the person skilled in the art. Preferably, the surface is a naturally occurring surface. As a non-limiting example, the surface may be a plant surface such as the surface of leaves, stem, roots, fruits, seeds, cones, flowers, bulbs or tubers, or it may be an insect surface, preferably as a part of the insect body that is accessible from the outside, such as, but not limited to, the exoskeleton of an insect.

Preferably, the specifically targeting microcapsules are binding so strongly that they are retained to the solid surface. “Retain,” as used herein, means that the binding force resulting from the affinity or avidity of either one single binding protein or a combination of two or more binding proteins or targeting agents comprising antigen binding proteins for its or their target molecule present at the solid surface is larger than the combined force and torque imposed by the gravity of the carrier, and the force and torque, if any, imposed by shear forces caused by one or more external factors.

Another aspect of the disclosure is a specifically targeting microcapsule, containing an agrochemical and comprising from about 0.01 μg to about 1 μg targeting agent per square cm microcapsule surface. Preferably, the specifically targeting microcapsule is produced, according to the process of the disclosure. Preferably, the targeting agent comprises an antigen binding protein. Even more preferably, the antigen binding protein is derived from a camelid antibody. Most preferably, the antigen binding protein is comprised in a VHH sequence.

A third aspect of the disclosure is an agrochemical composition comprising a suspension or dispersion of specifically targeting microcapsules in an aqueous medium.

It is preferred that the size distribution of the specifically targeting microcapsules in the suspension or dispersion falls within certain limits. Preferably, the volume-weighted mean diameter of the specifically targeting microcapsules of the agrochemical composition, according to the disclosure, is less than about 20 microns with at least 90%, on a volume basis, of the microcapsules having a diameter less than about 60 microns. More preferably, the volume-weighted mean diameter of the specifically targeting microcapsules is between about 2 and about 10 microns with at least 90%, on a volume basis, of the microcapsules having a diameter less than about 40 microns. Even more preferably, the volume-weighted mean diameter of the specifically targeting microcapsules is between about 2 and about 5 microns with at least 90%, on a volume basis, of the microcapsules having a diameter less than about 20 microns.

The aqueous medium in which the specifically targeting microcapsules are suspended or dispersed is preferably water and the aqueous suspension or dispersion of specifically targeting microcapsules is preferably formulated with additional additives to optimize its shelf life and in-use stability. Dispersants and/or thickeners may be used to inhibit the agglomeration and settling of microcapsules. Suitable dispersants are preferably high molecular weight, anionic or non-ionic dispersants, such as, but not limited to, naphthalene sulfonate sodium salt, gelatin, casein, polyvinyl alcohol, alkylated polyvinyl pyrrolidone polymers, sodium and calcium lignosulfonates, sulfonated naphthalene-formaldehyde condensates, modified starches, or modified cellulosics. Thickeners are useful in retarding the settling process by increasing the viscosity of the aqueous phase. Preferably shear-thinning thickeners are used, because they result in a reduction in viscosity of the suspension or dispersion during pumping, which facilitates the application and even coverage of the suspension or dispersion to the field using commonly used spraying equipment. Suitable examples of shear-thinning thickeners include, but are not limited to, guar- or xanthan-based gums, cellulose ethers or modified cellulosics and polymers. Anti-packing agents are useful to redisperse or resuspend the microcapsules upon agitation when microcapsules have settled. Suitable anti-packing agents include, but are not limited to, microcrystalline cellulose material, clay, silicon dioxide, or insoluble metal oxides.

A pH buffer may be used to maintain the pH of the suspension or dispersion. Suitable buffers such as disodium phosphate may be used to hold the pH in a range within which most of the components are most effective. Preferably, this range is between pH 4 and 9.

Other useful additives are biocides, preservatives, anti-freeze agents and antifoam agents.

In a preferred embodiment, the agrochemical composition comprising a suspension or dispersion of specifically targeting microcapsules in an aqueous medium has a stability that allows the composition of the disclosure to be suitably stored and transported and (where necessary after further dilution) applied to the intended site of action. Preferably, the agrochemical composition, according to the disclosure, is stable at least for two years at ambient temperature. Preferably, the agrochemical composition, according to the disclosure, is stable at least for fourteen days at 54° C. Preferably, the agrochemical composition, according to the disclosure, remains stable after at least one, preferably after more than one, freeze-thaw cycle. “Stable,” as used in this context, means that the total content of the agrochemical active substance present in the specifically targeting microcapsule suspension or dispersion shall not have been decreased with more than 10%, preferably not have been decreased with more than 5%, compared with the initial total content of the agrochemical active substance that was present in the specifically targeting microcapsule suspension or dispersion before applying the storage conditions. Preferably, in addition, the free (non-encapsulated) content of the agrochemical active substance present in the specifically targeting microcapsule suspension or dispersion shall not have been increased with more than 100%, more preferably not have been increased with more than 50%, most preferably not have been increased with more than 25%, compared with the initial free content of the agrochemical active substance that was present in the specifically targeting microcapsule suspension or dispersion before applying the storage conditions.

In yet another preferred embodiment, the agrochemical or combination of agrochemicals comprised in the specifically targeting microcapsules comprised in the agrochemical composition, according to the disclosure, is selected from the group consisting of fungicides, insecticides, herbicides, safeners, nematicides, acaricides, bactericides, pheromones, repellants, plant and insect growth regulators and fertilizers.

Preferably, the characteristics of the specifically targeting microcapsules comprised in the agrochemical composition, according to the disclosure, are such that maintaining them in suspension in a tank mix causes no difficulty and that they can withstand the pressure applied with spraying equipment, whether this spraying is performed with hand-applied equipment, machine-operated spraying equipment or even aerial spraying equipment.

A fourth aspect of the disclosure, is the use of an agrochemical composition, according to the disclosure, to protect a plant and/or to modulate the viability, growth or yield of a plant or plant parts and/or to modulate gene expression in a plant or plant parts.

In a preferred embodiment, the use of the agrochemical composition, according to the disclosure, comprises at least one application of a said composition to the plant or plant part. “One application,” as used herein, means a single treatment of a plant or plant part. According to this method, either the composition, according to the disclosure, is applied as such to the plant or plant part, or the composition is first dissolved, suspended and/or diluted in a suitable solution before being applied to the plant. The application to the plant is carried out using any suitable or desired manual or mechanical technique for application of an agrochemical or a combination of agrochemicals, including but not limited to, spraying, brushing, dressing, dripping, dipping, coating, spreading, applying as small droplets, a mist or an aerosol. Upon such application to a plant or part of a plant, the specifically targeting microcapsules comprising the agrochemical or combination of agrochemical can bind at or to the plant (part) surface via one or more antigen binding protein that form part of the targeting agent(s) comprised in the composition, preferably in a specific manner. Thereupon, the agrochemicals are released from the specifically targeting microcapsule (e.g., due to degradation of the microcapsule or passive transport through the wall of the microcapsule) in such a way that they can provide the desired agrochemical action(s). A particular advantage of applying an agrochemical or combination of agrochemicals to a plant or plant part using a composition, according to the disclosure, is that it may lead to an improved deposition of the agrochemical or combination of agrochemicals on the plant or plant part and/or an increased retention of the agrochemical or combination of agrochemicals as a result of increased resistance against loss due to external factors such as rain, dew, irrigation, snow, hail or wind.

In one preferred embodiment, applying an agrochemical or combination of agrochemicals to a plant using a composition, according to the disclosure, results in improved rainfastness of the agrochemical or combination of agrochemicals. “Improved rainfastness,” as used herein, means that the percentage loss of agrochemical or combination of agrochemicals, calculated before and after rain, is smaller when the agrochemical or combination of agrochemicals is applied in a composition, according to the disclosure, compared with the same agrochemical or combination of agrochemicals comprised in a comparable composition, without any targeting agent. A “comparable composition,” as used herein, means that the composition is identical to the composition, according to the disclosure, apart from the absence of the targeting agent used in the composition, according to the disclosure.

The agrochemical composition, according to the disclosure, may be the only material applied to a plant, preferably a crop, or it may be blended with other agrochemicals or additives for simultaneous application. Examples of agrochemicals, which may be blended for simultaneous application, include fertilizers, herbicide safeners, complimentary agrochemicals and even the free form of the encapsulated active substance. For a stand-alone application, the agrochemical composition, according to the disclosure, is preferably diluted with water prior to application to the field. Preferably, no additional additives are required to use the agrochemical composition for application in the field.

In a preferred embodiment, a suitable dose of the agrochemical or combination of agrochemicals comprised in a composition, according to the disclosure, is applied to the plant or plant part. A “suitable dose,” as used herein, means an efficacious amount of active substance of the agrochemical comprised in the composition. Generally, application rates of agrochemicals are in the order of grams up to kilograms of active substance per hectare. Preferably, application rates of agrochemicals comprised in the agrochemical composition, according to the disclosure, are in the range of 1 g to 1000 g of active substance per hectare, more preferably in the range of 1 g to 500 g of active substance per hectare, even more preferably in the range of 1 g to 300 g of active substance per hectare, most preferably in the range of 1 g to 200 g of active substance per hectare.

In another preferred embodiment, at least one application of an agrochemical composition, according to the disclosure, protects a plant against external (biotic or abiotic) stress and/or modulates the viability, growth or yield of a plant or plant parts and/or modulates gene expression in a plant or plant part resulting in alteration of (levels of) plant constituents (such as proteins, oils, carbohydrates, metabolites, etc.). “Protects a plant,” as used here, is the protection of the plant against any stress; the stress may be biotic stress, such as, but not limited to, stress caused by weeds, insects, rodents, nematodes, mites, fungi, viruses or bacteria, or it may be abiotic stress, such as, but not limited to, drought stress, salt stress, temperature stress or oxidative stress.

### EXAMPLES

### Example 1

### Preparation of Microcapsules

Microcapsules with broad spectrum herbicide glyphosate (N-(phosphonomethyl)glycine), pyrethroid insecticide lambda-cyhalothrin (3-(2-chloro-3,3,3-trifluoro-1-propenyl)-2,2-dimethyl-cyano(3-phenoxyphenyl)methyl cyclopropanecarboxylate), pyridine fungicide fluazinam (3-chloro-N-(3-chloro-5-trifluoromethyl-2-pyridyl)-α,α,α-trifluoro-2,6-dinitro-p-toluidine) or fluorescent dye Uvitex (2,5-thiophenediylbis(5-tert-butyl-1,3-benzoxazole)) (CIBA) were produced containing benzyl benzoate as solvent in the organic phase. Lambda-cyhalothrin, fluazinam, and Uvitex were dissolved in benzyl benzoate. Solid glyphosate was ground to <10 μm particles and dispersed in benzyl benzoate and the glyphosate coarse dispersion was encapsulated. Organic phase-soluble monomers used were 2,4-TDI (2,4-toluene diisocyanate) and PMPPI (Polymethylene polyphenyl isocyanate). Emulsifiers used were Tween-20 (Polyoxyethylene (20) sorbitan monolaurate), Tween-80 (Polyoxyethylene (80) sorbitan monooleate), SDS (Sodium lauryl sulfate), or PVA (polyvinyl alcohol or ethenol). Parameters such as rate and time of agitation, temperature for emulsification, concentration of active substances, and type and concentration of emulsifiers were optimized for each active substance until suitable mean diameter of oil droplets (o 1-10 μm) were obtained. Emulsions were analyzed by light microscopy and scanning electron microscopy. Interfacial polymerization reactions were initiated by addition of the amino acid lysine functioning as a diamine in the polymerization reaction and leaving carboxyl anchor groups available for subsequent microcapsule functionalization by linking of VHH, or tetraethylenepentamine (TEPA) functioning as a pentamine in the polymerization reaction leaving amine functional groups available for subsequent microcapsule functionalization by linking of VHH. In particular embodiments, microcapsules were produced using the amino acid lysine for its diamine functionality in the polycondensation reaction and leaving carboxyl anchor groups available for subsequent microcapsule functionalization whereas diethylenetriamine (DETA) was added as a cross-linker to the polymerization reaction to obtain desired microcapsule shell strength and release characteristics by increasing cross-linking of isocyanate monomers. It was found that the ratio lysine-DETA is preferably >9:1, even more preferably >99:1. In other particular embodiments, microcapsules were produced using the amino acid lysine for its diamine functionality in the interfacial polymerization reaction for 30 minutes and adding diethylenetriamine (DETA) after this time to obtain desired microcapsule shell strength and release characteristics by increasing cross-linking of isocyanate monomers. In specific embodiments, microcapsules were produced without use of DETA to obtain microcapsules with maximum shell functionality and quick release properties. In specific embodiments, the concentrations and ratio of TDI and PMPPI were adjusted to produce microcapsules with desired permeability of the shell without the use of DETA or other cross-linking agents.

### Example 2

### Preparation of Quick Release Microcapsules with Carboxyl Anchor Groups for Covalent Linking of VHH

A solution of 0.5% (w/w) SDS in water was prepared. 2,4-TDI isomer and PMPPI were dissolved each in 13% (w/w) concentration in benzyl benzoate containing active substance. Ratio of water phase-oil phase was approximately 9:1. Emulsion was prepared by ultra-turrax homogenization to obtain 5-10 μm droplets. Interfacial polymerization was initiated by drop-wise addition of 16.7% (w/w) lysine solution and curing of the microcapsules was performed for 30 minutes at 40° C. In total approximately 9% (w/w) of lysine solution was added.

### Example 3

### Preparation of Slow Release Microcapsules with Carboxyl Anchor Groups for Covalent Linking of VHH

A solution of 0.5% (w/w) SDS in water was prepared. 2,4-TDI isomer and PMPPI were dissolved each in 13% (w/w) concentration in benzyl benzoate containing active substance. Ratio of water phase-oil phase was approximately 9:1. Emulsion was prepared by ultra-turrax homogenization to obtain 5-10 μm droplets. Interfacial polymerization was initiated by drop-wise addition of 16.7% (w/w) lysine solution and curing of the microcapsules was performed for 30 minutes at 40° C. In total approximately 9% (w/w) of lysine solution was added. Microcapsule shells were strengthened by subsequent drop-wise addition of 25% (w/w) of DETA solution and curing of the microcapsules was performed for 30 minutes at 40° C. In total approximately 5.5% (w/w) of DETA solution was added.

### Example 4

### Preparation of Microcapsules with Amine Anchor Groups for Covalent Linking of VHH

A solution of 0.5% (w/w) SDS in water was prepared. 2,4-TDI isomer and PMPPI were dissolved each in 6.7% (w/w) concentration in benzyl benzoate containing active substance. Ratio of water phase-oil phase was approximately 9:1. Emulsion was prepared by ultra-turrax homogenization to obtain 5-10 μm droplets. Interfacial polymerization was initiated by drop-wise addition of 5% (w/w) TEPA solution and curing of the microcapsules was performed for 60 minutes at 40° C. In total approximately 14% (w/w) of TEPA solution was added.

### Example 5

### Analysis of the Microcapsules

Particle size, particle distribution, and morphology of the microcapsules were analyzed using dynamic light scattering (DLS), light microscopy, confocal light microscopy, and scanning electron microscopy (SEM). Quick release microcapsules with carboxyl anchor groups for covalent linking of VHH were produced with volume weighted mean diameter D[4.3] of 4.71 μm (batch 117) and little span. Slow release microcapsules with carboxyl anchor groups for covalent linking of VHH were produced with volume weighted mean diameters D[4.3] of 10.0 μm (batch 113) with little span, or 4.68 μm (batch 121) with little span. Microcapsules with amine anchor groups for covalent linking of VHH were produced with volume weighted mean diameters D[4.3] of 9.63 μm (batch p36) and little span or 10.3 μm (batch 119) and little span. It was found that intact spherical microcapsules were obtained for microcapsules produced with lysine alone, microcapsules produced with both lysine and DETA, and microcapsules produced with TEPA alone. Slight differences in microcapsule surface smoothness were observed between different protocols.

### Example 6

### Covalent Linking of Targeting Agents to the Microcapsules

Subsequent covalent linking of VHH molecules to microcapsules requires microcapsules that allow buffer exchange, and mixing. Filtration test were performed on different scale using 0.45 μm 96-well deep-well filtration plates (Millipore), a vacuum-tight filter flask and P 1.6 glass filter funnel (Duran) with a maximum pore size of 1.6 μm, or vacuum-tight filter flask and φ47 mm hydrophilic PVDF Durapore 0.45 membranes (Millipore). It was found that both quick release and slow release microcapsules with carboxyl anchor groups and microcapsules with amine anchor groups could be filtered and withstand treatments allowing for covalent linking of VHH to microcapsules (e.g., batches 113, 121, p36, 119). Use of certain surfactants such as PVA required a centrifugation step before filtration. It was found that microcapsules could be spun down and withstand centrifugation at 1500×g and next be filtered similar to microcapsules that had been produced using, e.g., SDS as surfactant.

For quick or slow release microcapsules with carboxyl anchor groups, or microcapsules with amine anchor groups, the covalent linking of VHH was carried out as follows:

Microcapsules were extensively washed to amine-free aqueous buffer. VHH were dialyzed to appropriate amine-free aqueous buffer and added to the microcapsules. The amount of VHH that was added to the microcapsules was optimized taking into account the surface area of the spherical microcapsules and physical dimensions of VHH antibody fragments (for dimensions of VHH see Muyldermans et al., 2009). Linking reactions were performed with VHH amounts aiming at coupling VHH between 1 E+05 and 1 E+06 VHH molecules/square μm. Thus, aiming at ideal coverage of microcapsule surface or using up to 10-fold excess of VHH molecules over the amount that could ideally be packed on the microcapsule surface. Coupling reactions were performed with allowance for cross-linking of VHH using EDC (1-ethyl-3-[3-dimethylaminopropyl]carbodiimide hydrochloride) in a 1-step coupling chemistry or without allowance of such cross-linking using EDC with or without NHS (N-hydroxysuccinimide) or Sulfo-NHS (N-hydroxysulfosuccinimide) in an activation step of microcapsules with carboxyl groups, and after sufficient washing, coupling of VHH to the microcapsule surface in a second step.

### Example 7

### Analysis of the Specific Targeting of Functionalized Microcapsules

The amount of covalently linked VHH to microcapsules was measured by assaying the amount of unbound protein and subtracting it from the amount of starting protein using a Bradford protein assay (Coomassie Plus (Bradford) Assay (Pierce)). Bradford protein assay reagent was also used to measure the amount of protein immobilized on the microcapsules utilizing the shift in absorbance of the coomassie dye from 465 nm to 595 nm in the presence of protein (table 1). 5-point standard curves were used. Similar results between the two methods were observed and it was found that VHH were highly efficiently coupled to microcapsule shells with measured efficiency between 12 and 92%, resulting in a high density of targeting agents at the microcapsule surface.

TABLE 1

| | | | Amount of VHH | Number of VHH present per |
|---|---|---|---|---|
| | | | added in coupling | square micron on microcapsule |
| VHH | Microcapsules | Functionality | reaction | surface |
| VHH | Batch 113 | Carboxyl | 1 μg/cm2 | 1.7^{E}+04 |
| 001 | | | | |
| VHH | Batch 121 | Carboxyl | 0.5 μg/cm2 | 3.41^{E}+04 |
| 001 | | | | |
| VHH | Batch p36 | Amine | 1 μg/cm2 | Not detemiined |
| 001 | | | | |
| VHH | Batch 113 | Carboxyl | 1 μg/cm2 | 1.29^{E}+05 |
| 801 | | | | |

Binding of VHH-functionalized microcapsules to surfaces with coated antigens was investigated. Half area multi-well plates were coated with corresponding antigens in optimal concentrations to specificities for VHH 001 and VHH 801. Plates were coated with antigens in PBS overnight at 4° C. and blocked and washed the next day. VHH functionalized microcapsules and blank microcapsules were added and allowed to bind. Consecutive washes were performed to remove non-specifically bound microcapsules. It was found that microcapsules with coupled VHH were binding in function of the specificity of the coupled VHH (table 2).

TABLE 2
binding efficacy of the microcapsules

| | | | Coating for VHH 001 | Coating for VHH 801 |
|---|---|---|---|---|
| | | | binding signal | binding signal |
| | | | (fluorescence) - Potato | (fluorescence) - Chitin |
| VHH | Microcapsules | Functionality | lectin coating | coating |
| VHH | Batch 113 | Carboxyl | 20339 | 1991 |
| 001 | | | | |
| VHH | Batch 113 | Carboxyl | 3573 | 10621 |
| 801 | | | | |
| Without | Batch 113 | Carboxyl | 3206 | 2101 |
| VHH | | | | |
| VHH | Batch p36 | Amine | 13937 | Not determined |
| 001 | | | | |
| Without | Batch p36 | Amine | 1240 | Not determined |
| VHH | | | | |

Binding of microcapsules with VHH 001 specific for potato lectin to potato plant leaf surfaces was investigated. Microcapsule counts were measured after washing leaf discs to remove non-specifically bound microcapsules. It was found that microcapsules with VHH 001 were specifically binding to leaf surface (table 3).

TABLE 3
binding of the microcapsules to leaf surface

| VHH | Microcapsules | Functionality | Potato leaf surface |
|---|---|---|---|
| VHH 001 | Batch 113 | Carboxyl | 3959 |
| VHH 801 | Batch 113 | Carboxyl | 716 |
| Without | Batch 113 | Carboxyl | 444 |
| VHH | | | |

### Example 8

### Manufacturing of Microcapsules with Carboxyl Anchor Groups Using Lysine as the Amine Source by Interfacial Polymerization

Uvitex OB was dissolved to 1.7% (w/w) in Benzyl Benzoate. Polymethylene polyphenyl isocyanate (PMPPI) and 2,4 Toluene diisocyanate (TDI) (1:1) were added to 13% (w/w) and mixed. The organic phase was emulsified in a solution of 0.5 0.5% (w/w) SDS in water, using homogenization with an Ultra-Turrax disperser. A solution of 17% (w/w) lysine in water was added under mixing with a marine impeller and polymerization performed at 40° C. for 30 minutes. For the production of slow release microcapsules, a solution of 25% (w/w) DETA in water was added after the polymerization reaction with lysine and polymerization continued at 40° C. for 30 minutes. Microcapsules were washed with water and collected. The mean volume-weighted diameter of the microcapsules was 6.1 μm.

Covalent linking of VHH to microcapsules. Microcapsules were washed to appropriate amine-free buffers using vacuum filtration and concentrated. VHH were dialyzed to the same buffer and concentrated by spin filtration. VHH were added and mixed with the microcapsules. A premix of EDC and Sulfo-NHS was made immediately before use and added. Final concentration of EDC in the reaction was 2 mM, final concentration of Sulfo-NHS in the reaction was 5 mM. Final concentration of VHH in the coupling reaction was 1 mg/ml or 0.5 mg/ml. The calculated maximum density of VHH added to the coupling reactions was 1 μg/cm2 (4.3E+05 VHH molecules/μm2 microcapsule surface), 0.5 μg/cm2 (2.1E+05 VHH molecules/μm2 microcapsule surface), or 0.25 μg/cm2 (1.1E+05 VHH molecules/μm2 microcapsule surface). Covalent linking reactions were performed at room temperature for 2 hours or overnight with slow tilt agitation or head-over-head rotation. Reactions were quenched by the addition of amine-containing Tris or glycine solution. Reaction mixtures were transferred to a filtration setup and non-linked VHH were collected by vacuum filtration for analysis. VHH-coupled microcapsules were washed twice with appropriate buffer in a filtration setup and collected in the same buffer.

Functionality of VHH-linked microcapsules. High-binding microtiter plates were coated with antigens corresponding to the specificity of the coupled VHH. Wells coated with unrelated antigens were used as controls. Plates were washed and blocked with skimmed milk. A calculation was made for how many microcapsules were to be added to a well for full coverage of the bottom of the well. Microcapsules were added to full coverage of the wells, or serial dilutions were made and added to the wells. Microcapsules with antigen-specific VHH and control microcapsules were diluted to appropriate densities in skimmed milk, added to the wells, and allowed to bind. Non-bound microcapsules were removed by consecutive washes. Wells were filled with wash buffer, shaken on an ELISA shaking platform ≧900 rpm, and microcapsules in suspension removed together with the wash buffer. Bound microcapsules were visualized using a macrozoom microscope system (Nikon) and counted using Volocity image analysis software (PerkinElmer); the number of bound microcapsules per microtiter plate well is shown in table 4. Microcapsules coupled with antigen-specific VHH at 1, 0.5, or 0.25 μg VHH per cm2 microcapsule surface are specifically binding to antigen-containing surfaces with the application rates tested from 0.2 0.2% to 25% coverage. Moreover, it can be anticipated that application rates beyond these values will also result in specific binding of microcapsules with antigen-specific VHH.

TABLE 4
Carboxyl microcapsules produced with lysine as the amine source and
EDC/Sulfo-NHS mediated coupling of VHH

| | | Antigen- | Antigen- | Antigen- | |
|---|---|---|---|---|---|
| | Antigen- | binding | binding | binding | Blank |
| | binding VHH | VHH | VHH | VHH | microcapsules |
| VHH concentration | 1 | 1 | 0.5 | 0.5 | |
| in coupling reaction | | | | | |
| (mg/ml) | | | | | |
| Calculated | 1 | 0.5 | 0.5 | 0.25 | |
| maximum density | | | | | |
| (μg VHH/cm2 | | | | | |
| microcapsule | | | | | |
| surface) | | | | | |
| Potato lectin | 11287 | 9611 | 8898 | 6978 | 2501 |
| coat/25% coverage | | | | | |
| (# microcapsules) | | | | | |
| Potato lectin | 4936 | 3445 | 3605 | 2723 | 633 |
| coat/5% coverage | | | | | |
| (# microcapsules) | | | | | |
| Potato lectin | 1109 | 1006 | 1257 | 833 | 184 |
| coat/1% coverage | | | | | |
| (# microcapsules) | | | | | |
| Potato lectin0.2 | 237 | 181 | 195 | 160 | 52 |
| coat/0.2% coverage | | | | | |
| (# microcapsules) | | | | | |
| No coat/25% | 1758 | 1559 | 1952 | 1718 | 2641 |
| coverage | | | | | |
| (# microcapsules) | | | | | |

In another experiment the final concentration of VHH in the covalent linking reaction was 1 mg/ml, 0.3 mg/ml, 0.1 mg/ml, or 0.04 mg/ml. The calculated maximum density of VHH on the microcapsule surface that was added to the reaction mixtures was 1 μg/cm2 (4.3E+05 VHH molecules/μm2 microcapsule surface), 0.3 μg/cm2 (1.4E+05 VHH molecules/μm2 microcapsule surface), 0.1 μg/cm2 (4.7E+04 VHH molecules/μm2 microcapsule surface), or 0.04 μg/cm2 (1.6E+04 VHH molecules/μm2 microcapsule surface). Functionality of the microcapsules was analyzed for microcapsules coupled with antigen-specific VHH and compared to microcapsules coupled with a control VHH, tables 5 & 6. Microcapsules coupled with antigen-specific VHH at 1, 0.3, 0.1, or 0.04 μg VHH per cm2 microcapsule surface are specifically binding to antigen-containing surfaces with the application rates tested from 4% to 100% coverage. Moreover, it can be anticipated that application rates beyond these values will also result in specific binding of microcapsules with antigen-specific VHH.

TABLE 5
Carboxyl microcapsules produced with lysine as the amine
source and EDC/Sulfo-NHS mediated coupling of VHH

| | Anti- | | | Anti- | | |
|---|---|---|---|---|---|---|
| | gen- | Con- | Fold | gen- | Con- | Fold |
| | binding | trol | differ- | binding | trol | differ- |
| | VHH | VHH | ence | VHH | VHH | ence |
| VHH | 1 | 1 | | 0.3 | 0.3 | |
| concentration in | | | | | | |
| coupling reaction | | | | | | |
| (mg/ml) | | | | | | |
| Calculated | 1 | 1 | | 0.3 | 0.3 | |
| maximum density | | | | | | |
| (μg VHH/cm2 | | | | | | |
| microcapsule | | | | | | |
| surface) | | | | | | |
| Potato lectin coat/ | 33914 | 1571 | 22 | 8779 | 1443 | 6.1 |
| 100% coverage | | | | | | |
| (# microcapsules) | | | | | | |
| Potato lectin coat/ | 8992 | 436 | 21 | 4111 | 396 | 10 |
| 20% coverage | | | | | | |
| (# microcapsules) | | | | | | |
| Potato lectin coat/ | 3082 | 94 | 33 | 1564 | 92 | 17 |
| 4% coverage | | | | | | |
| (# microcapsules) | | | | | | |
| No coat/ | 562 | 1104 | 0.5 | 492 | 971 | 0.5 |
| 100% coverage | | | | | | |
| (# microcapsules) | | | | | | |

TABLE 6
Carboxyl microcapsules produced with lysine as the amine
source and EDC/Sulfo-NHS mediated coupling of VHH

| | Anti- | | | Anti- | | |
|---|---|---|---|---|---|---|
| | gen- | Con- | Fold | gen- | Con- | Fold |
| | binding | trol | differ- | binding | trol | differ- |
| | VHH | VHH | ence | VHH | VHH | ence |
| VHH | 0.1 | 0.1 | | 0.04 | 0.04 | |
| concentration in | | | | | | |
| coupling reaction | | | | | | |
| (mg/ml) | | | | | | |
| Calculated | 0.1 | 0.1 | | 0.04 | 0.04 | |
| maximum density | | | | | | |
| (μg VHH/cm2 | | | | | | |
| microcapsule | | | | | | |
| surface) | | | | | | |
| Potato lectin coat/ | 2079 | 719 | 2.9 | 565 | 657 | 0.9 |
| 100% coverage | | | | | | |
| (# microcapsules) | | | | | | |
| Potato lectin coat/ | 2044 | 80 | 26 | 146 | 114 | 1.3 |
| 20% coverage | | | | | | |
| (# microcapsules) | | | | | | |
| Potato lectin coat/ | 477 | 10 | 48 | 32 | 13 | 2.5 |
| 4% coverage | | | | | | |
| (# microcapsules) | | | | | | |
| No coat/ | 392 | 488 | 0.8 | 367 | 455 | 0.8 |
| 100% coverage | | | | | | |
| (# microcapsules) | | | | | | |

### Example 9

### Manufacturing of Microcapsules with Carboxyl Groups Using the Dipeptide H-Lys-Glu-OH as the Amine Source by Interfacial Polymerization

Uvitex OB was dissolved to 1.6% (w/w) in Benzyl Benzoate. Polymethylene polyphenyl isocyanate (PMPPI) and 2,4 Toluene diisocyanate (TDI) (1:1) were added to 13% (w/w) and mixed. The organic phase was emulsified in a solution of 0.5 0.5% (w/w) SDS in water, using homogenization with an Ultra-Turrax disperser. A solution of 12.5% (w/w) H-Lys-Glu-OH in water was added under mixing with a marine impeller and interfacial polymerization performed at 40° C. Microcapsules were washed with water and collected. The mean volume-weighted diameter of the microcapsules was 6.1 μm.

Covalent linking of VHH to microcapsules. Microcapsules were washed to appropriate amine-free buffers using vacuum filtration and concentrated. VHH were dialyzed to the same buffer and concentrated by spin filtration. VHH were added and mixed with the microcapsules. A premix of EDC and Sulfo-NHS was made immediately before use and added. Final concentration of EDC in the reaction was 2 mM, final concentration of Sulfo-NHS in the reaction was 5 mM. Final concentration of VHH in the covalent linking reaction was 1 mg/ml. The calculated maximum density of VHH added to the coupling reactions was 1 μg/cm2 (4.3E+05 VHH molecules/μm2 microcapsule surface). Covalent linking reactions were performed at room temperature for 2 hours with slow tilt agitation or head-over-head rotation. Reactions were quenched by the addition of amine-containing glycine solution. Reaction mixtures were transferred to a filtration setup and non-linked VHH were collected by vacuum filtration for analysis. VHH-linked microcapsules were washed twice with appropriate buffer in a filtration setup and collected in the same buffer. Functionality of the microcapsules was analyzed for microcapsules coupled with antigen-specific VHH and compared to microcapsules covalently linked with a control VHH, table 7. Microcapsules with antigen-specific VHH are specifically binding to antigen-containing surfaces over surfaces not containing the antigen. Microcapsules with antigen-specific VHH are binding to antigen-containing surfaces over surfaces not containing the antigen in both application rates tested of 5% and 25% coverage. Moreover, it can be anticipated that application rates beyond these values will also result in specific binding of microcapsules with antigen-specific VHH.

TABLE 7
Carboxyl microcapsules produced with dipeptide H-Lys-Glu-OH as the
amine source and EDC/Sulfo-NHS mediated coupling of VHH

| | Antigen-binding | Control | Fold |
|---|---|---|---|
| | VHH | VHH | difference |
| VHH concentration in | 1 | 1 | |
| coupling reaction (mg/ml) | | | |
| Calculated maximum | 1 | 1 | |
| density (μg VHH/cm2 | | | |
| microcapsule surface) | | | |
| Potato lectin coat/25% | 9995 | 749 | 13 |
| coverage (# microcapsules) | | | |
| Potato lectin coat/5% | 3121 | 79 | 40 |
| coverage (# microcapsules) | | | |
| No coat/25% coverage | 969 | 838 | 1.2 |
| (# microcapsules) | | | |
| No coat/5% coverage | 144 | 73 | 2.0 |
| (# microcapsules) | | | |

### Example 10

### Manufacturing of Microcapsules with Amine Functional Groups and VHH Coupling Through Amine-Reactive Homobifunctional Cross-Linkers

Uvitex OB was dissolved in 1.7% (w/w) in Benzyl Benzoate. Polymethylene polyphenyl isocyanate (PMPPI) and 2,4 Toluene diisocyanate (TDI) (1:1) were added to 6% (w/w) and mixed. The organic phase was emulsified in a solution of 0.5 0.5% (w/w) SDS using homogenization with an Ultra-Turrax disperser. Alternatively Tween-80 was used as surfactant at 0.5 0.5% (w/w) concentration and stirring performed with an overhead stirrer. A solution of 5% (w/w) TEPA in water was added under mixing with a marine impeller and interfacial polymerization performed at 40° C. for 30 minutes. Alternatively an overhead stirrer was used, the pH adjusted to pH 12, and interfacial polymerization performed at room temperature overnight. Microcapsules were washed with water and collected. The mean volume-weighted diameter of the microcapsules obtained was ±10 μm.

Covalent linking of VHH to microcapsules using EDC/Sulfo-NHS. Microcapsules were washed to appropriate amine-free buffers using vacuum filtration and concentrated. VHH were dialyzed to the same buffer and concentrated by spin filtration. VHH were added and mixed with the microcapsules. A premix of EDC and Sulfo-NHS was made immediately before use and added. Final concentration of EDC in the reaction was 2 mM, final concentration of Sulfo-NHS in the reaction was 5 mM. Final concentration of VHH in the reaction mixture was 1 mg/ml or 0.1 mg/ml. The calculated maximum density of VHH added to the reaction mixtures was 1 μg/cm2 (4.3E+05 VHH molecules/μm2 microcapsule surface), or 0.1 μg/cm2 (4.3E+04 VHH molecules/μm2 microcapsule surface). Covalent linking reactions were performed at room temperature overnight with slow tilt agitation or head-over-head rotation. Reactions were quenched by the addition of amine-containing glycine solution. Coupling reactions were transferred to a filtration setup and non-coupled VHH were collected by vacuum filtration for analysis. VHH-coupled microcapsules were washed twice with appropriate buffer in a filtration setup and collected in the same buffer.

Coupling of VHH to microcapsules using BS3 cross-linker in a 1-step procedure. Microcapsules were washed to appropriate amine-free buffer using vacuum filtration and concentrated. VHH were dialyzed to the same buffer and concentrated by spin filtration. VHH were added and mixed with the microcapsules. BS3 ((bis[sulfosuccinimidyl]suberate) cross-linker was dissolved immediately before use and added to the reaction mix in 10-fold molar excess over the VHH concentration. Final concentration of VHH in the reaction mix was 1 mg/ml or 0.1 mg/ml. The calculated maximum density of VHH added to the reaction mixtures was 1 μg/cm2 (4.3E+05 VHH molecules/μm2 microcapsule surface), or 0.1 μg/cm2 (4.3E+04 VHH molecules/μm2 microcapsule surface). Covalent linking reactions were performed at room temperature overnight with slow tilt agitation or head-over-head rotation. Reactions were quenched by the addition of amine-containing glycine solution. Reaction mixtures were transferred to a filtration setup and non-linked VHH were collected by vacuum filtration for analysis. VHH-linked microcapsules were washed twice with appropriate buffer in a filtration setup and collected in the same buffer.

Coupling of VHH to microcapsules using BS3 cross-linker in a 2-step procedure. Microcapsules were washed to appropriate amine-free buffer using vacuum filtration and concentrated. VHH were dialyzed to the same buffer and concentrated by spin filtration. BS3 ((bis[sulfosuccinimidyl]suberate) cross-linker was dissolved immediately before use and added to the microcapsules in 2.5 mM concentration and allowed to react for 30 minutes at room temperature with slow tilt agitation or head-over-head rotation. After incubation activated microcapsules were transferred to a filtration setup and washed twice with appropriate buffer. Microcapsules with activated groups were collected in the same buffer. VHH were added immediately and mixed with the microcapsules. Final concentration of VHH in the reaction mix was 1 mg/ml or 0.1 mg/ml. The calculated maximum density of VHH added to the reaction mixtures was 1 μg/cm2 (4.3E+05 VHH molecules/μm2 microcapsule surface), or 0.1 μg/cm2 (4.3E+04 VHH molecules/μm2 microcapsule surface). Covalent linking reactions were performed at room temperature overnight with slow tilt agitation or head-over-head rotation. Reactions were quenched by the addition of amine-containing glycine solution. Covalent linking reactions were transferred to a filtration setup and non-linked VHH were collected by vacuum filtration for analysis. VHH-linked microcapsules were washed twice with appropriate buffer in a filtration setup and collected in the same buffer.

Functionality of the microcapsules was analyzed for microcapsules covalently linked with antigen-specific VHH and compared to microcapsules covalently linked with a control VHH, tables 8-10. Microcapsules with antigen-specific VHH covalently linked to amine groups of the microcapsule by means of EDC/Sulfo-NHS are specifically binding to antigen-containing surfaces. Microcapsules covalently linked with antigen-specific VHH at 1 or 0.1 μg VHH per cm2 microcapsule surface are specifically binding to antigen-containing surfaces with the application rates tested from 4% to 100% coverage. Moreover, it can be anticipated that application rates beyond these values will also result in specific binding of microcapsules with antigen-specific VHH.

Microcapsules with antigen-specific VHH covalently linked to amine groups of the microcapsule by means of a BS3 homobifunctional cross-linker in a 1-step protocol are specifically binding to antigen-containing surfaces. Microcapsules covalently linked with antigen-specific VHH at 1 or 0.1 μg VHH per cm2 microcapsule surface are specifically binding to antigen-containing surfaces with the application rates tested from 4% to 100% coverage. Moreover, it can be anticipated that application rates beyond these values will also result in specific binding of microcapsules with antigen-specific VHH.

Microcapsules with antigen-specific VHH covalently linked to amine groups of the microcapsule by means of a BS3 homobifunctional cross-linker in a 2-step protocol are specifically binding to antigen-containing surfaces. Microcapsules covalently linked with antigen-specific VHH at 1 or 0.1 μg VHH per cm2 microcapsule surface are specifically binding to antigen-containing surfaces with the application rates tested from 4% to 100% coverage. Moreover, it can be anticipated that application rates beyond these values will also result in specific binding of microcapsules with antigen-specific VHH. The best ratios of specific microcapsule binding to antigen-containing surfaces are obtained with specific VHH covalently linked to amine groups of the microcapsule by means of a BS3 homobifunctional cross-linker in a 1-step coupling procedure.

TABLE 8
Amine microcapsules EDC/Sulfo-NHS coupling

| | Anti- | | | Anti- | | |
|---|---|---|---|---|---|---|
| | gen- | Con- | Fold | gen- | Con- | Fold |
| | binding | trol | differ- | binding | trol | differ- |
| Microcapsule counts | VHH | VHH | ence | VHH | VHH | ence |
| VHH | 1 | 1 | | 0.1 | 0.1 | |
| concentration in | | | | | | |
| coupling reaction | | | | | | |
| (mg/ml) | | | | | | |
| Calculated | 1 | 1 | | 0.1 | 0.1 | |
| maximum density | | | | | | |
| (μg VHH/cm2 | | | | | | |
| microcapsule | | | | | | |
| surface) | | | | | | |
| Potato lectin coat/ | 2190 | 312 | 7.0 | 868 | 333 | 2.6 |
| 100% coverage | | | | | | |
| (# microcapsules) | | | | | | |
| Potato lectin coat/ | 1821 | 64 | 28 | 610 | 106 | 5.8 |
| 20% coverage | | | | | | |
| (# microcapsules) | | | | | | |
| Potato lectin coat/ | 686 | 15 | 46 | 314 | 16 | 20 |
| 4% coverage | | | | | | |
| (# microcapsules) | | | | | | |
| No coat/ | 269 | 315 | 0.9 | 333 | 258 | 1.3 |
| 100% coverage | | | | | | |
| (# microcapsules) | | | | | | |

TABLE 9
Amine microcapsules 1-step coupling BS3

| | Anti- | | | Anti- | | |
|---|---|---|---|---|---|---|
| | gen- | Con- | Fold | gen- | Con- | Fold |
| | binding | trol | differ- | binding | trol | differ- |
| | VHH | VHH | ence | VHH | VHH | ence |
| VHH | 1 | 1 | | 0.1 | 0.1 | |
| concentration in | | | | | | |
| coupling reaction | | | | | | |
| (mg/ml) | | | | | | |
| Calculated | 1 | 1 | | 0.1 | 0.1 | |
| maximum density | | | | | | |
| (μg VHH/cm2 | | | | | | |
| microcapsule | | | | | | |
| surface) | | | | | | |
| Potato lectin coat/ | 35051 | 85 | 412 | 1536 | 627 | 2.4 |
| 100% coverage | | | | | | |
| (# microcapsules) | | | | | | |
| Potato lectin coat/ | 9794 | 16 | 612 | 1149 | 212 | 5.4 |
| 20% coverage | | | | | | |
| (# microcapsules) | | | | | | |
| Potato lectin coat/ | 1942 | 3 | 647 | 474 | 76 | 6.2 |
| 4% coverage | | | | | | |
| (# microcapsules) | | | | | | |
| No coat/ | 95 | 91 | 1.0 | 673 | 442 | 1.5 |
| 100% coverage | | | | | | |
| (# microcapsules) | | | | | | |

TABLE 10
Amine microcapsules 2-step coupling BS3

| | Anti- | | | Anti- | | |
|---|---|---|---|---|---|---|
| | gen- | Con- | Fold | gen- | Con- | Fold |
| | binding | trol | differ- | binding | trol | differ- |
| | VHH | VHH | ence | VHH | VHH | ence |
| VHH | 1 | 1 | | 0.1 | 0.1 | |
| concentration in | | | | | | |
| coupling reaction | | | | | | |
| (mg/ml) | | | | | | |
| Calculated | 1 | 1 | | 0.1 | 0.1 | |
| maximum density | | | | | | |
| (μg VHH/cm2 | | | | | | |
| microcapsule | | | | | | |
| surface) | | | | | | |
| Potato lectin coat/ | 2681 | 380 | 7 | 1418 | 839 | 1.7 |
| 100% coverage | | | | | | |
| (# microcapsules) | | | | | | |
| Potato lectin coat/ | 1829 | 163 | 11 | 851 | 351 | 2.4 |
| 20% coverage | | | | | | |
| (# microcapsules) | | | | | | |
| Potato lectin coat/ | 790 | 50 | 16 | 361 | 119 | 3.0 |
| 4% coverage | | | | | | |
| (# microcapsules) | | | | | | |
| No coat/ | 747 | 379 | 2.0 | 817 | 1024 | 0.8 |
| 100% coverage | | | | | | |
| (# microcapsules) | | | | | | |

In another experiment it was investigated how differently functionalized microcapsules are binding to surfaces with different antigen densities. Functionality of the microcapsules was analyzed for microcapsules covalently linked with antigen-specific VHH and compared to microcapsules covalently linked with a control VHH, tables 11-13. Microcapsules with antigen-specific VHH covalently linked to carboxyl or amine anchor groups of microcapsules by means of different covalent linking procedures are specifically binding to antigen-containing surfaces. Microcapsules covalently linked with antigen-specific VHH at 1 or 0.1 μg VHH per cm2 microcapsule surface are specifically binding to antigen-containing surfaces with the application rates tested 10% or 100% coverage. Microcapsules with antigen-specific VHH are specifically binding to surfaces with different antigen densities. Moreover, it can be anticipated that application rates beyond these values will also result in specific binding of microcapsules with antigen-specific VHH. The best ratios of specific microcapsule binding to surfaces with different antigen densities and different application rates are obtained with specific VHH coupled to amine groups of the microcapsule by means of a BS3 homobifunctional cross-linker in a 1-step covalent linking procedure.

TABLE 11
Sample ID and coupling conditions

| | | | VHH | Calculated |
|---|---|---|---|---|
| | | | concentration | maximum density |
| | | | in coupling | (μg VHH/cm2 |
| | Microcapsule | | reaction | microcapsule |
| Sample | functional groups | VHH | (mg/ml) | surface) |
| A | Carboxyl | Antigen | 1 | 1 |
| | (EDC/Sulfo-NHS | binding | | |
| | coupling) | | | |
| B | Carboxyl | Antigen | 0.1 | 0.1 |
| | (EDC/Sulfo-NHS | binding | | |
| | coupling) | | | |
| C | Carboxyl | Control | 1 | 1 |
| | (EDC/Sulfo-NHS | | | |
| | coupling) | | | |
| D | Carboxyl | Control | 0.1 | 0.1 |
| | (EDC/Sulfo-NHS | | | |
| | coupling) | | | |
| E | Amine (BS-3 | Antigen | 1 | 1 |
| | cross-linker | binding | | |
| | 1-step coupling) | | | |
| F | Amine (BS-3 | Antigen | 0.1 | 0.1 |
| | cross-linker | binding | | |
| | 1-step coupling) | | | |
| G | Amine (BS-3 | Control | 1 | 1 |
| | cross-linker | | | |
| | 1-step coupling) | | | |
| H | Amine (BS-3 | Control | 0.1 | 0.1 |
| | cross-linker | | | |
| | 1-step coupling) | | | |
| I | Amine (BS-3 | Antigen | 1 | 1 |
| | cross-linker | binding | | |
| | 2-step coupling) | | | |
| J | Amine (BS-3 | Antigen | 0.1 | 0.1 |
| | cross-linker | binding | | |
| | 2-step coupling) | | | |
| K | Amine (BS-3 | Control | 1 | 1 |
| | cross-linker | | | |
| | 2-step coupling) | | | |
| L | Amine (BS-3 | Control | 0.1 | 0.1 |
| | cross-linker | | | |
| | 2-step coupling) | | | |

TABLE 12
Microcapsule counts

| | A | C | B | D | A | C | B | D |
|---|---|---|---|---|---|---|---|---|
| Potato | 100% | 100% | 100% | 100% | 10% | 10% | 10% | 10% |
| lectin | cov- | cov- | cov- | cov- | cov- | cov- | cov- | cov- |
| coat | er- | er- | er- | er- | er- | er- | er- | er- |
| (μg/ml) | age | age | age | age | age | age | age | age |
| 100 | 23696 | 297 | 4195 | 515 | 5154 | 55 | 2229 | 125 |
| 10 | 2755 | 265 | 2035 | 475 | 2752 | 50 | 1621 | 118 |
| 1 | 363 | 193 | 530 | 227 | 435 | 49 | 233 | 64 |
| 0 | 542 | 266 | 481 | 589 | 77 | 69 | 223 | 113 |
| | E | G | F | H | E | G | F | H |
| Potato | 100% | 100% | 100% | 100% | 10% | 10% | 10% | 10% |
| lectin | cov- | cov- | cov- | cov- | cov- | cov- | cov- | cov- |
| coat | er- | er- | er- | er- | er- | er- | er- | er- |
| (μg/ml) | age | age | age | age | age | age | age | age |
| 100 | 43052 | 150 | 2842 | 622 | 8959 | 36 | 699 | 225 |
| 10 | 35580 | 104 | 1693 | 780 | 6330 | 13 | 720 | 215 |
| 1 | 2001 | 46 | 1062 | 173 | 1572 | 7 | 284 | 36 |
| 0 | 202 | 190 | 975 | 973 | 119 | 67 | 142 | 196 |

| | I | K | J | L | I | K | J | L |
|---|---|---|---|---|---|---|---|---|
| Potato | 100% | 100% | 100% | 100% | 10% | 10% | 10% | 10% |
| lectin | cov- | cov- | cov- | cov- | cov- | cov- | cov- | cov- |
| coat | er- | er- | er- | er- | er- | er- | er- | er- |
| (μg/ml) | age | age | age | age | age | age | age | age |
| 100 | 3573 | 866 | 3244 | 1111 | 1409 | 285 | 667 | 248 |
| 10 | 2166 | 903 | 2406 | 787 | 904 | 197 | 484 | 186 |
| 1 | 1022 | 617 | 1235 | 860 | 385 | 215 | 290 | 116 |
| 0 | 1233 | 1163 | 1798 | 1368 | 319 | 366 | 227 | 273 |

TABLE 13
Fold difference between microcapsule samples

| | A over C | A over C | B over D | B over D |
|---|---|---|---|---|
| Potato lectin coat | 100% | 10% | 100% | 10% |
| (μg/ml) | coverage | coverage | coverage | coverage |
| 100 | 80 | 94 | 8 | 18 |
| 10 | 10 | 55 | 4 | 14 |
| 1 | 2 | 9 | 2 | 4 |
| 0 | 2 | 1 | 1 | 2 |
| | E over G | E over G | F over H | F over H |
| Potato lectin coat | 100% | 10% | 100% | 10% |
| (μg/ml) | coverage | coverage | coverage | coverage |
| 100 | 287 | 249 | 5 | 3 |
| 10 | 342 | 487 | 2 | 3 |
| 1 | 44 | 225 | 6 | 8 |
| 0 | 1 | 2 | 1 | 1 |
| | I over K | I over K | J over L | J over L |
| Potato lectin coat | 100% | 10% | 100% | 10% |
| (μg/ml) | coverage | coverage | coverage | coverage |
| 100 | 4 | 5 | 3 | 3 |
| 10 | 2 | 5 | 3 | 3 |
| 1 | 2 | 2 | 1 | 3 |
| 0 | 1 | 1 | 1 | 1 |

### Example 11

### Functionality of Microcapsules with Antigen-Specific VHH for Binding to Plant Leaves

Microcapsules with antigen-specific VHH or control VHH were topically applied at 100%, 10%, 1%, or 0.1% coverage to leaf discs prepared from outside-grown plants. Non-bound microcapsules were removed by placing the leaf discs floating upside down on wells filled with buffer and shaking on an ELISA shaking platform ≧900 rpm for 45 minutes. Washed leaf discs were analyzed for bound microcapsules using a macrozoom microscope system (Nikon) and microcapsules counted using Volocity image analysis software (PerkinElmer); the average number of microcapsules for each condition is shown in tables 14 and 15. Microcapsules with antigen-specific VHH covalently linked to carboxyl or amine anchor groups of microcapsules by means of different linking methods are specifically binding to leaves. Microcapsules covalently linked with antigen-specific VHH are specifically binding to leaves with the application rates tested 0.1%, 1%, 10% or 100% coverage for the delivery of active substances (AS). This can be calculated to be suitable for delivery of agrochemicals on greenhouse or field crops in the range of 24 g AS/ha to 8.5 kg AS/ha (Table 16).

TABLE 14
Microcapsules with carboxyl anchor groups, covalently linked in a
1-step protocol with antigen-specific VHH bound and retained on potato
leaf discs

| | Antigen- | | Control | | |
|---|---|---|---|---|---|
| | binding VHH | | VHH | | |
| | Average | Stdev | Average | Stdev | Fold difference |
| 100% coverage | 25901 | 7307 | 3843 | 467 | 6.7 |
| 10% coverage | 8278 | 3226 | 682 | 47 | 12 |
| 1% coverage | 1680 | 393 | 161 | 49 | 10 |
| 0.1% coverage | 320 | 44 | 34 | 6 | 9.3 |

TABLE 15
Microcapsules with amine anchor groups, covalently linked in a
1-step protocol using BS3 cross-linker with antigen-specific VHH, bound
and retained on potato leaf discs

| | Antigen- | | Control | | |
|---|---|---|---|---|---|
| | binding VHH | | VHH | | |
| | Average | Stdev | Average | Stdev | Fold difference |
| 100% coverage | 25621 | 3285 | 1335 | 77 | 19 |
| 10% coverage | 4270 | 375 | 588 | 168 | 7.3 |
| 1% coverage | 902 | 216 | 170 | 68 | 5.3 |
| 0.1% coverage | 125 | 46 | 39 | 24 | 3.2 |

TABLE 16
Calculated delivery of active substances with microcapsules with
antigen-specific VHH

| | Microcapsules | Microcapsule | | Microcapsule |
|---|---|---|---|---|
| | counted | amount | Microcapsules | amount on |
| | on 0.5 cm2 | on 0.5 cm2 | counted on 0.5 cm2 | 0.5 cm2 leaf |
| | leaf disc | leaf disc (mg) | leaf disc | disc (mg) |
| Microcapsule | 100% | 100% coverage | 0.1% coverage | 0.1% |
| diameter (μm) | coverage | | | coverage |
| 6,1 (carboxyl | 25901 | 2.46E−02 | 320 | 3.05E−04 |
| microcapsule) | | | | |
| 10 (amine | 25621 | 1.07E−01 | 125 | 5.22E−04 |
| microcapsules) | | | | |
| | | | | Assuming |
| | Microcapsule | | | active |
| | amount | Microcapsule | Assuming active | substance 40% |
| | calculated per | amount calculated | substance 40% | load |
| | hectare (g) | per hectare (g) | load (g/ha) | (g/ha) |
| Microcapsule | 100% | 0.1% coverage | 100% coverage | 0.1% |
| diameter (μm) | coverage | | | coverage |
| 6,1 (carboxyl | 4.90E+03 | 6.06E+01 | 2.0E+03 | 2.4E+01 |
| microcapsule) | | | | |
| 10 (amine | 2.14E+04 | 1.04E+02 | 8.5E+03 | 4.2E+01 |
| microcapsules) | | | | |

### REFERENCES

Blake, A. W., McCartney, L., Flint, J., Bolam, D. N., Boraston, A. B., Gilbert, H. J. and Knox, J. P. (2006) Understanding the biological rationale for the diversity of cellulose-directed carbohydrate-binding molecules in prokaryotic enzymes. J. Biol. Chem. 281, 29321-29329.
Cozens-Roberts, C., Quinn, J. A., Lauffenburger, D. A. (1990) Receptor-mediated cell attachment and detachment kinetics. Biophys. J. 58, 857-872.
Dimitrov, D. S. (2009) Engineered CH2 domains (nanoantibodies). mAbs 1, 26-28.
Kolmar, H. (2008) Alternative binding proteins: biological activity and therapeutic potential of cysteine-knot miniproteins. FEBS J. 275, 2684-2690.
Kuo, S. C. and Lauffenburger, D. A. (1993) Relationship between receptor/ligand binding affinity and adhesion strength. Biophys. J. 65, 2191-2200.
Mason, B. P., Hira, S. M., Strouse, G. F. and McQuade, D. T. (2009) Microcapsules with three orthogonal reactive sites. Org. Lett. 11, 1479-1482.
Muyldermans S, Baral T N, Retamozzo V C, De Baetselier P, De Genst E, Kinne J, Leonhardt H, Magez S, Nguyen V K, Revets H, Rothbauer U, Stijlemans B, Tillib S, Wernery U, Wyns L, Hassanzadeh-Ghassabeh G, Saerens D. (2009) Camelid immunoglobulins and nanobody technology. Vet Immunol Immunopathol. 128, 178-83.
Ni, P., Zhang, M., and Yan, N. (1995) Effect of operating varibales and monomers on the formation of polyurea microcapsules. Journal of Membrane Science 103, 51-55.
Nygren, P-A. (2008) Alternative binding proteins: affibody binding proteins developed from a small three-helix bundle scaffold. FEBS J. 275, 2668-2676.
Scher, H. B., Rodson, M. and Lee, K-S. (1998) Microencapsulation of pesticides by interfacial polymerization utilizing isocyanate or aminoplast chemistry. Pestic. Sci. 54, 394-400.
Skerra, A. (2008) Alternative binding proteins: anticalins—harnessing the structural plasticity of the lipocalin ligand pocket to engineer novel binding activities. FEBS J. 275, 2677-2683.
Stump, M. T., Binz, H. K., Amstutz, P. (2008) DARPins: a new generation of protein therapeutics. Drug iscov. Today 13, 695-701.
Tramontano, A., Bianchi, E., Venturini, S., Martin, F., Pessi, A and Sollazzo, M. (1994) The making of the minibody: an engineered beta-protein for the display of confromationally constrained peptides. J. Mol. Recognition 7, 9-24.
Wesolowski, J., Alzogaray, V., Reyelt, J., Unger, M., Juarez, K., Urrutia, M., Cauerhiff, A., Danquah, W., Rissiek, B., Scheuplin, F., Schwarz, N., Adriouch, S., Boyer, O., Seman, M., Licea, A., Serreze, D. V., Goldbaum, F. A., Haag, F. and Koch-Nolte, F. (2009). Single domain antibodies: promising experimental and therapeutic tools in infection and immunity. Med. Microbiol. Immunol. 198, 157-174.

1. A process for manufacturing specifically targeting microcapsules, the process comprising at least the steps of:
a. emulsifying into a continuous aqueous phase, an organic phase in which a to be encapsulated agrochemical or combination of agrochemicals is dissolved or dispersed to form an emulsion of droplets of the organic phase in the continuous aqueous phase;
b. causing an aqueous suspension of microcapsules with polymer walls having anchor groups at their surface to be formed; and
c. covalently linking at least one targeting agent to the anchor groups at the microcapsule surface, at a ratio from about 0.01 μg to about 1 μg targeting agent per square cm microcapsule surface.

2. The process according to claim 1, wherein the process comprises the steps of:
emulsifying into a continuous aqueous phase comprising a surfactant, an organic phase in which a to be encapsulated agrochemical or combination of agrochemicals together with polyfunctional monomers or prepolymers are dissolved or dispersed to form an emulsion of droplets of the organic phase in the continuous aqueous phase;
adding to the emulsion a monomer- or prepolymer-reactant component containing anchor groups;
causing polymerization of the monomers or prepolymers to form an aqueous suspension of microcapsules having anchor groups at their surface; and
covalently linking at least one targeting agent to the anchor groups at the microcapsule surface, at a ratio from about 0.01 μg to about 1 μg targeting agent per square cm microcapsule surface.

3. The process according to claim 1, the process comprising:
emulsifying into a continuous aqueous phase comprising a surfactant, an organic phase in which a to be encapsulated agrochemical or combination of agrochemicals, together with a prepolymer or mixture of prepolymers containing anchor groups, is dissolved or dispersed to form an emulsion of droplets of the organic phase in the continuous aqueous phase;
causing in situ self-condensation of the prepolymers surrounding the droplets of organic phase to form an aqueous suspension of microcapsules having polymer walls with anchor groups at their surface; and
covalently linking at least one targeting agent to the anchor groups at the microcapsule surface, at a ratio from about 0.01 μg to about 1 μg targeting agent per square cm microcapsule surface.

4. The process according to claim 1, wherein the process comprises the steps of:
emulsifying into a continuous aqueous phase comprising a surfactant, an organic phase in which a to be encapsulated agrochemical or combination of agrochemicals is dissolved or dispersed to form an emulsion of droplets of the organic phase in the continuous aqueous phase;
adding to the continuous aqueous phase a water-soluble prepolymer or mixture of prepolymers, containing anchor groups;
causing in situ self-condensation of the prepolymers surrounding the droplets of organic phase to form an aqueous suspension of microcapsules with polymer walls having anchor groups at their surface; and
covalently linking at least one targeting agent to the anchor groups at the microcapsule surface, at a ratio from about 0.01 μg to about 1 μg targeting agent per square cm microcapsule surface.

5. The process of claim 1, wherein the targeting agent comprises an antigen binding protein.

6. The process according to claim 5, wherein the antigen binding protein is derived from a camelid antibody.

7. The process according to claim 6, wherein the antigen binding protein is comprised in a VHH.

8. A specifically targeting microcapsule, produced by the process of claim 1.

9. The specifically targeting microcapsule, according to claim 8, capable of binding an agrochemical or combination of agrochemicals to a surface.

10. The specifically targeting microcapsule of claim 8, wherein the targeting agent comprises an antigen binding protein.

11. The specifically targeting microcapsule according to claim 10, wherein the antigen binding protein is derived from a camelid antibody.

12. The specifically targeting microcapsule according to claim 11, wherein the antigen binding protein is comprised in a VHH sequence.

13. An agrochemical composition comprising:
a suspension or dispersion of specifically targeting microcapsules of claim 8 in an aqueous medium.

14. A method of modulating a plant or plant part's viability, growth, and/or yield and/or modulating gene expression in a plant or plant parts, the method comprising:
utilizing the agrochemical composition according to claim 13 to protect the plant and/or to modulate the viability, growth or yield of a plant or plant parts and/or to modulate gene expression in a plant or plant parts.

15. The specifically targeting microcapsule of claim 9, wherein the targeting agent comprises an antigen binding protein.

16. The specifically targeting microcapsule of claim 15, wherein the antigen binding protein is derived from a camelid antibody.

17. The specifically targeting microcapsule of claim 16, wherein the antigen binding protein is comprised in a VHH sequence.

18. An agrochemical composition comprising:
a suspension or dispersion of the specifically targeting microcapsules of claim 9 in an aqueous medium.

19. The process of claim 2, wherein the targeting agent comprises an antigen binding protein.

20. The process of claim 3, wherein the targeting agent comprises an antigen binding protein.

21. The process of claim 4, wherein the targeting agent comprises an antigen binding protein.
